(19) United States
(12) Patent Application Publication
(10) Pub. No.: US 2025/0212023 A1
(43) Pub. Date: Jun. 26, 2025

(54) Network Energy Saving Management

(71) Applicant: Ofinno, LLC, Reston, VA (US)

(72) Inventors: Peyman Talebi Fard, Vienna, VA (US); SungDuck Chun, Fairfax, VA (US); Esmael Hejazi Dinan, McLean, VA (US); Kyungmin Park, Vienna, VA (US); Henrik Andreas Normann, Münich (DE); Taehun Kim, Fairfax, VA (US); Jian Xu, McLean, VA (US); Stanislav Filin, Chantilly, VA (US)

(21) Appl. No.: 18/987,491

(22) Filed: Dec. 19, 2024

Related U.S. Application Data
(60) Provisional application No. 63/613,279, filed on Dec. 21, 2023.

(51) Int. Cl. H04W 24/02; H04L 41/14; H04W 52/02

(52) U.S. Cl. CPC H04W 24/02; H04L 41/14; H04W 52/02

(57) ABSTRACT

An SMF receives, from a PCF, a policy control create message comprising a condition for triggering a policy control request, wherein the condition comprises a change in energy saving state of a network function (NF), wherein the energy saving state is associated with at least one of a network slice, a quality of service (QOS) flow, and a protocol data unit (PDU) session of a wireless device. The SMF receives, from a network data analytics function (NWDAF), a message notifying that the change in the energy saving state of the NF has occurred, and determines, based on the message, that the condition is met. The SMF sends, to the PCF, a policy control update indicating that the condition is met.

### CROSS-REFERENCE TO RELATED APPLICATIONS

This application claims the benefit of U.S. Provisional Application No. 63/613,279, filed Dec. 21, 2023, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 is a diagram of an aspect of an example embodiment of the present disclosure.

FIG. 16 is a diagram of an aspect of an example embodiment of the present disclosure.

FIG. 17 is a diagram of an aspect of an example embodiment of the present disclosure.

FIG. 18 is a diagram of an aspect of an example embodiment of the present disclosure.

FIG. 19 is a diagram of an aspect of an example embodiment of the present disclosure.

FIG. 20 is a diagram of an aspect of an example embodiment of the present disclosure.

FIG. 21 is a diagram of an aspect of an example embodiment of the present disclosure.

FIG. 22 is a diagram of an aspect of an example embodiment of the present disclosure.

FIG. 23 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

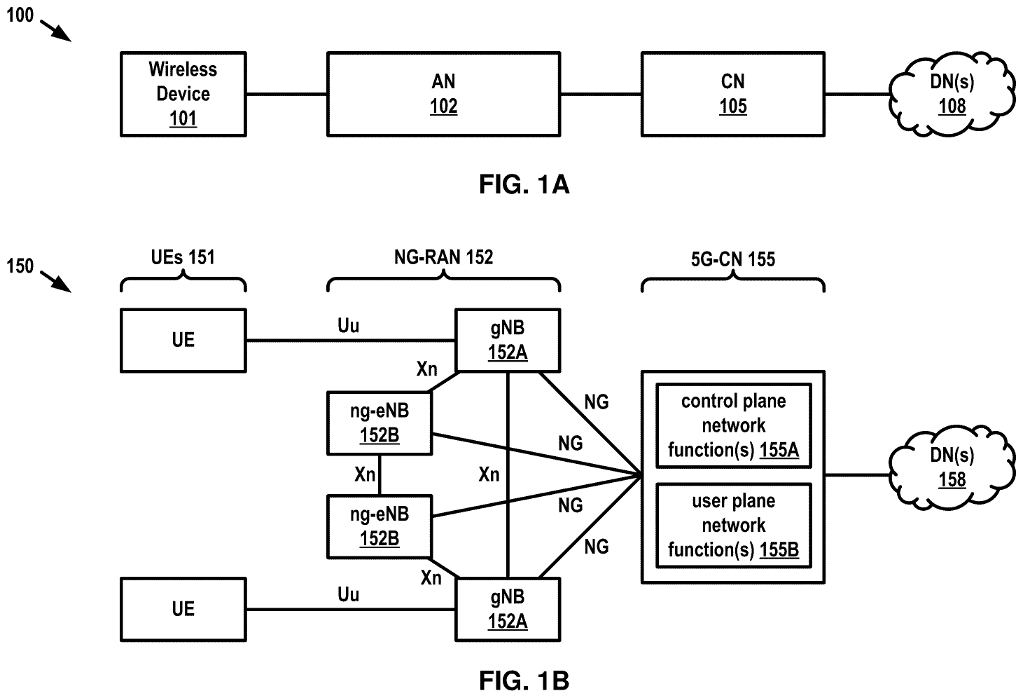

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNS (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

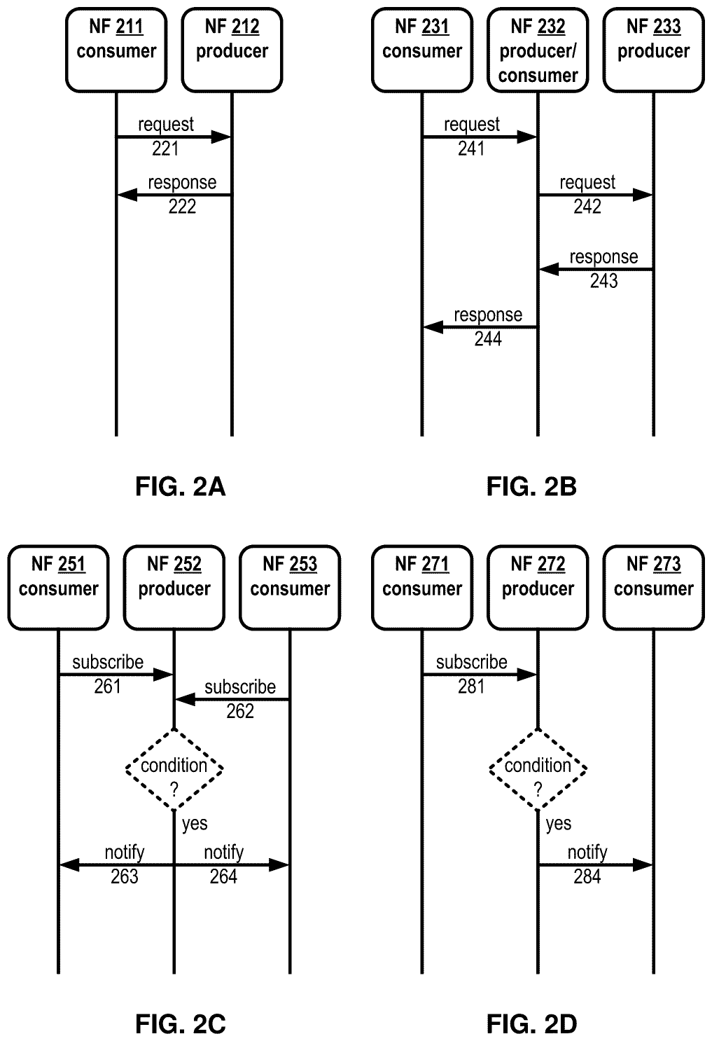

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

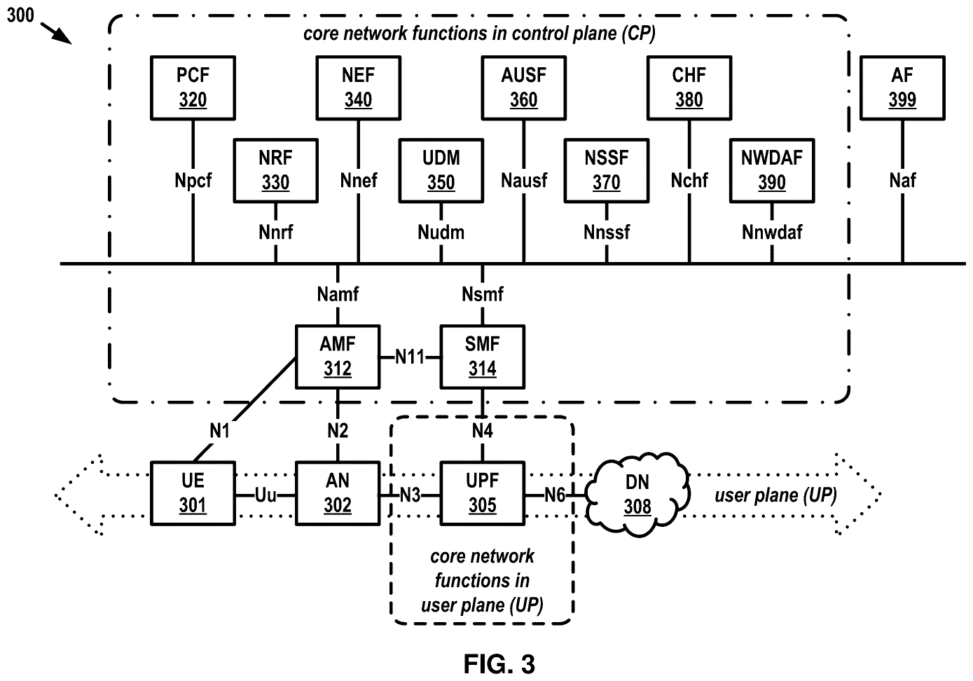

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QOS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC 220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

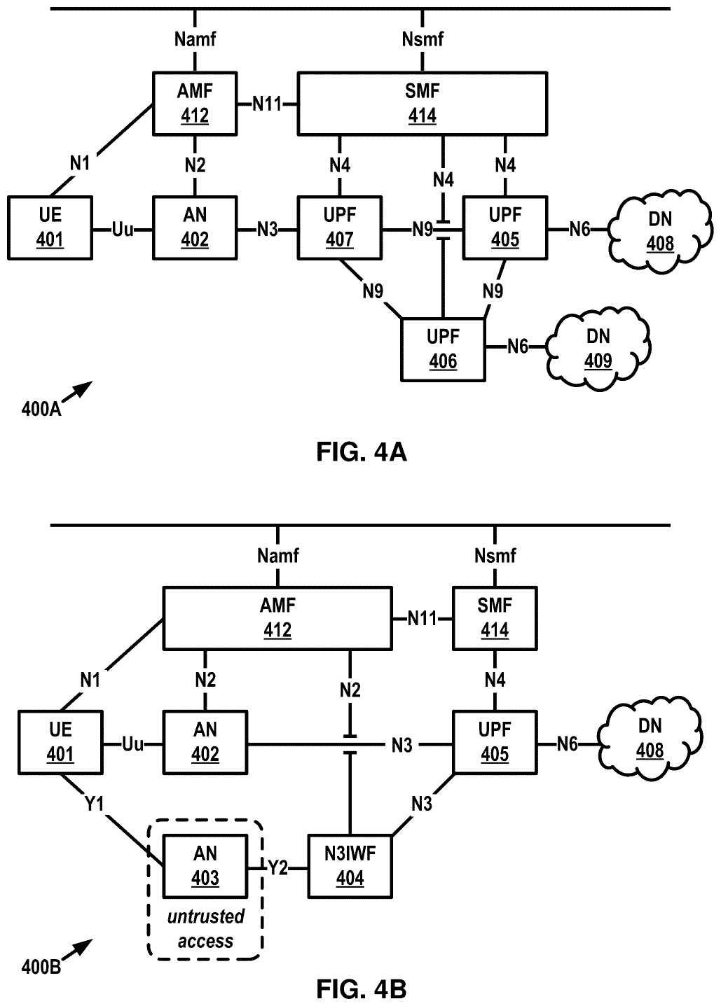

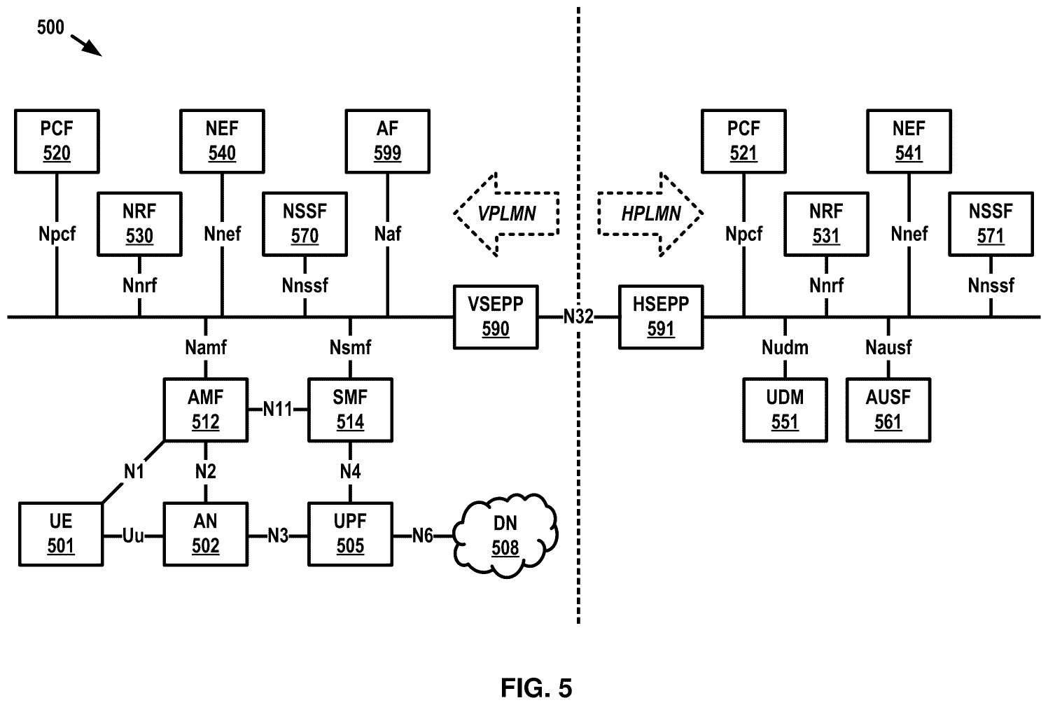

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number of downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNS (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

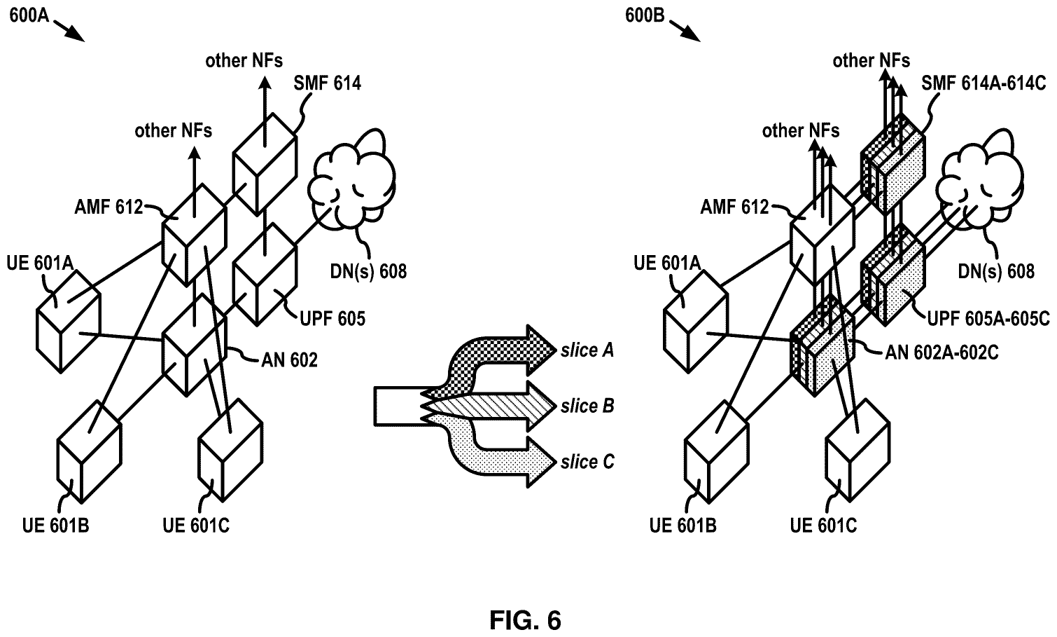

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). As an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

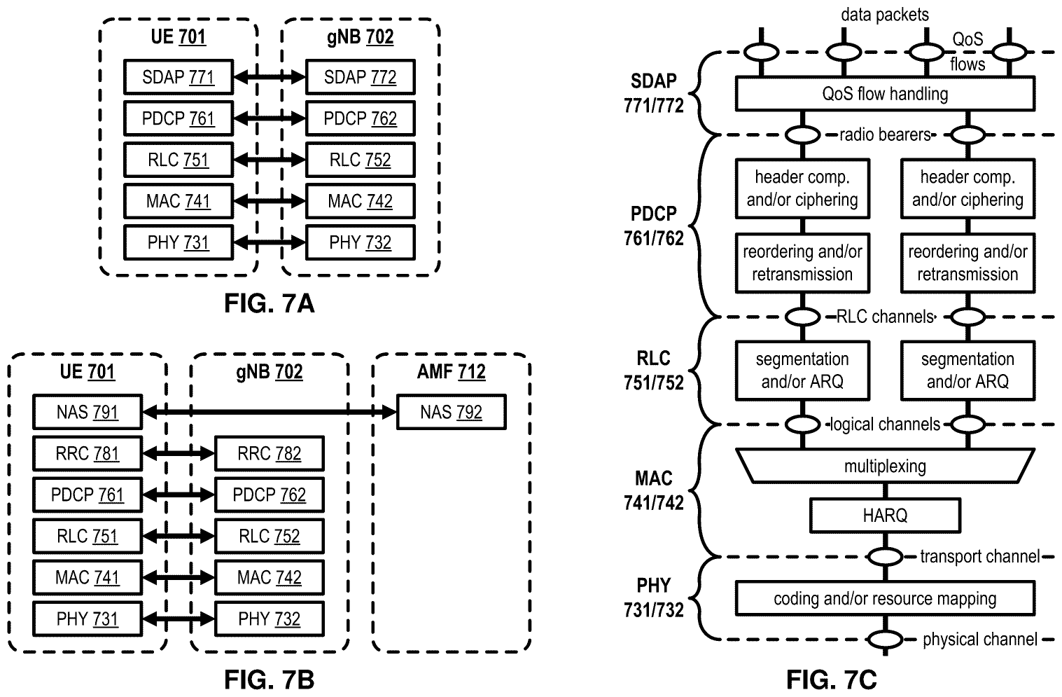

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QOS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

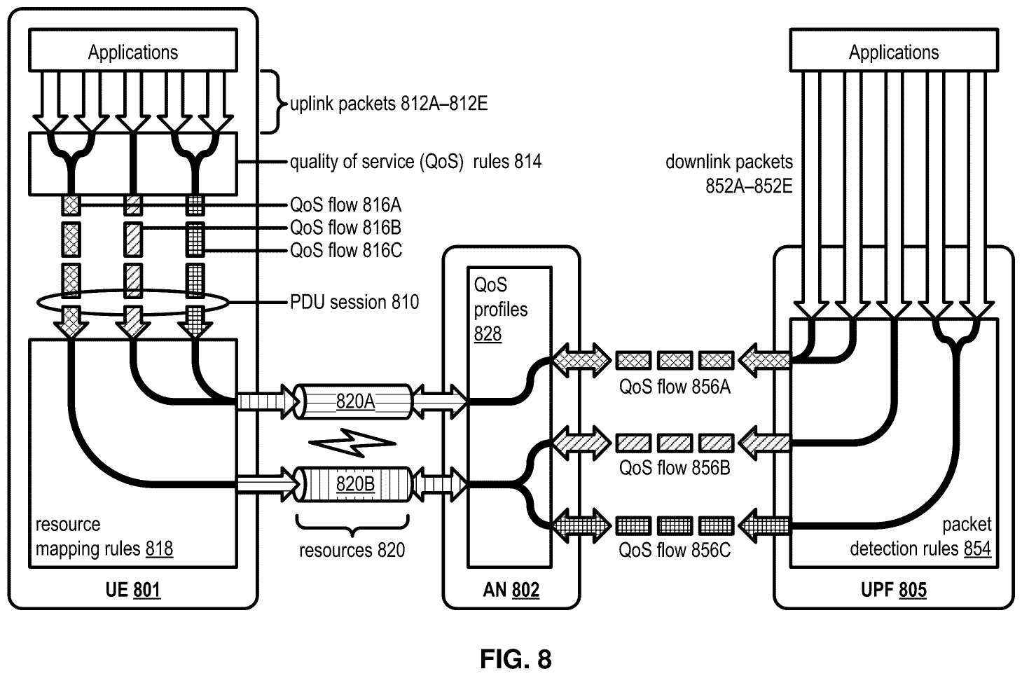

FIG. 8 illustrates an example of a quality of service (QOS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

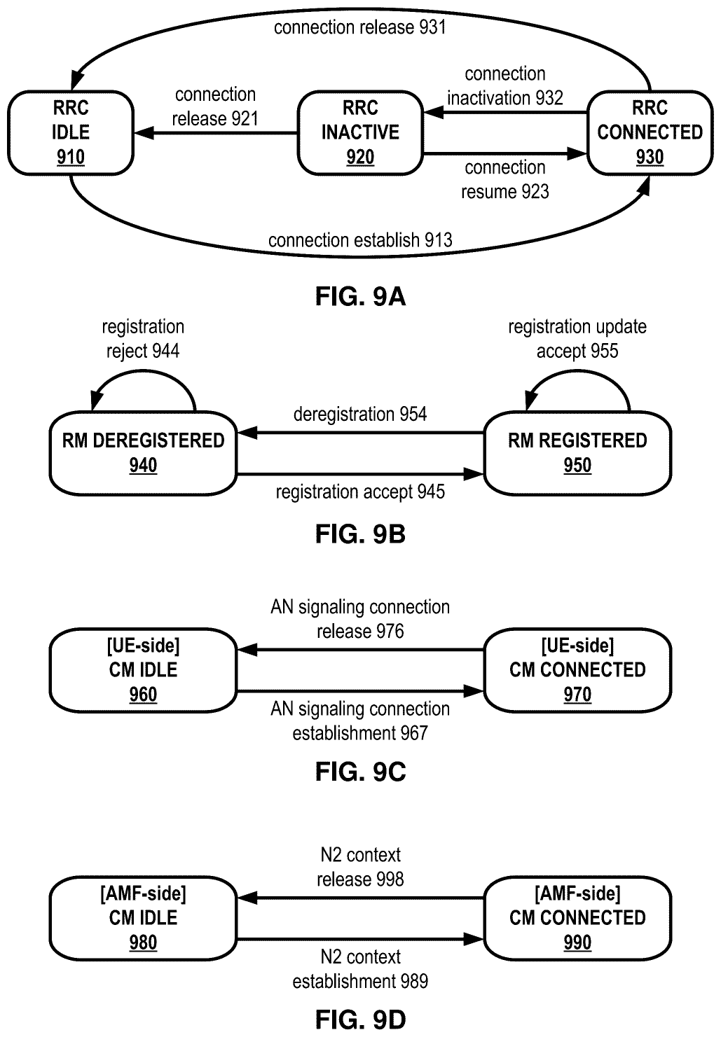

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, .e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF may release the N2 context of the UE (N2 context release 998).

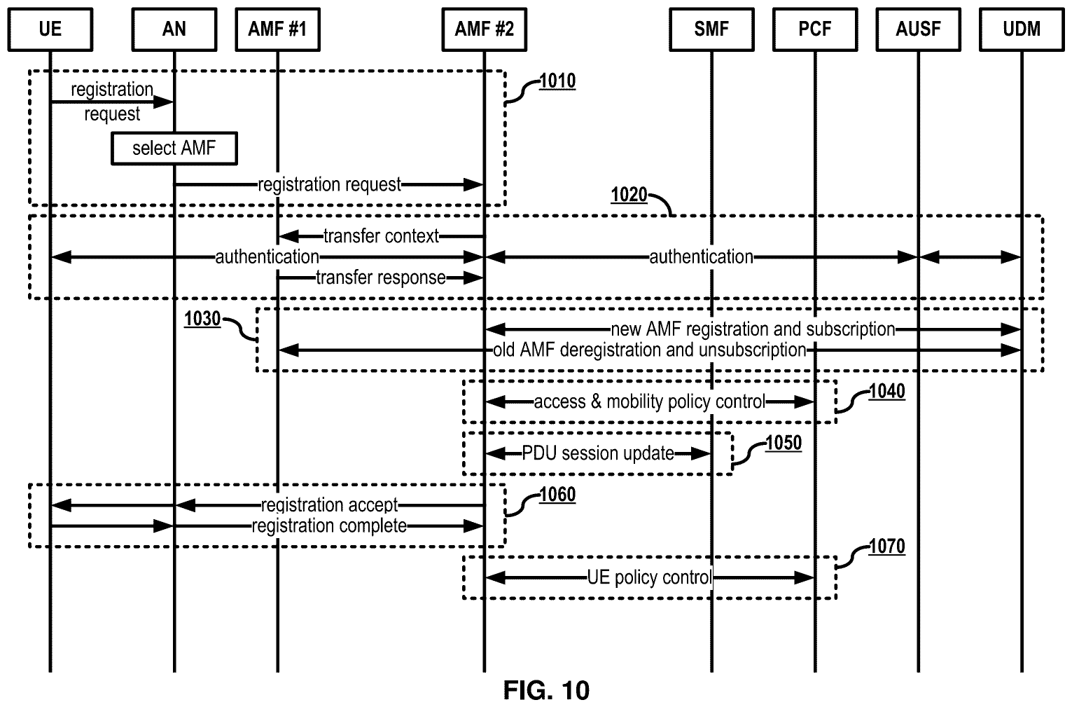

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

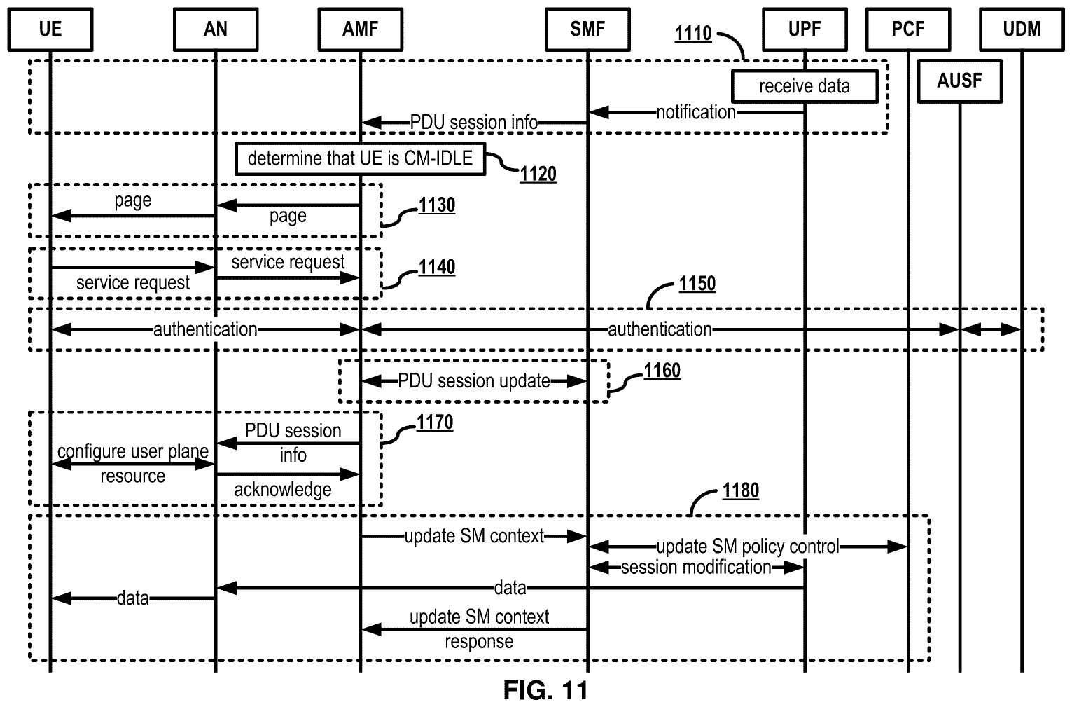

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

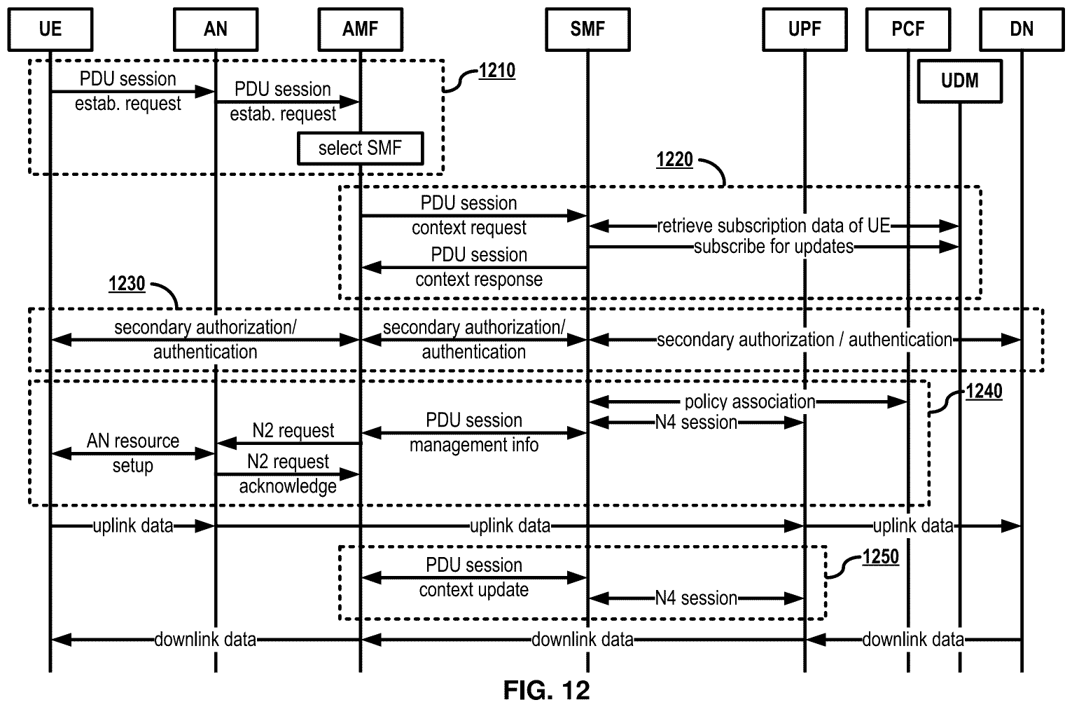

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPV4, IPV6, or dual stack IPV4/IPV6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a session service request (e.g., Namf_Communication_N1N2MessageTransfer) message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QOS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

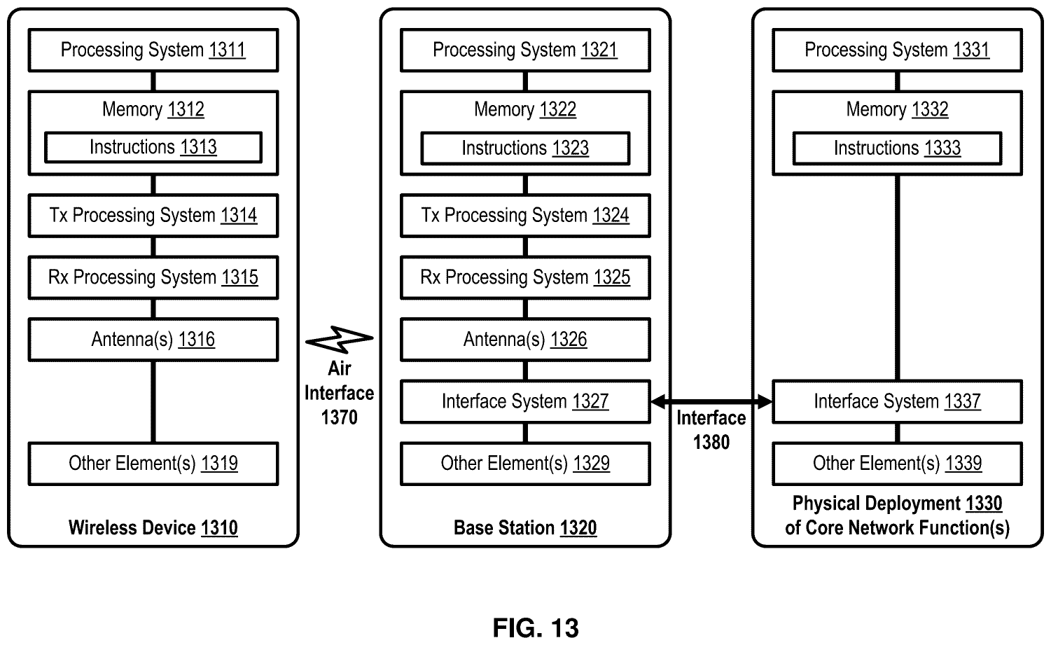

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab and/or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICS, FPGAs, and complex programmable logic devices (CPLDs). Computers, microcontrollers and microprocessors may be programmed using languages such as assembly, C, C++ and/or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

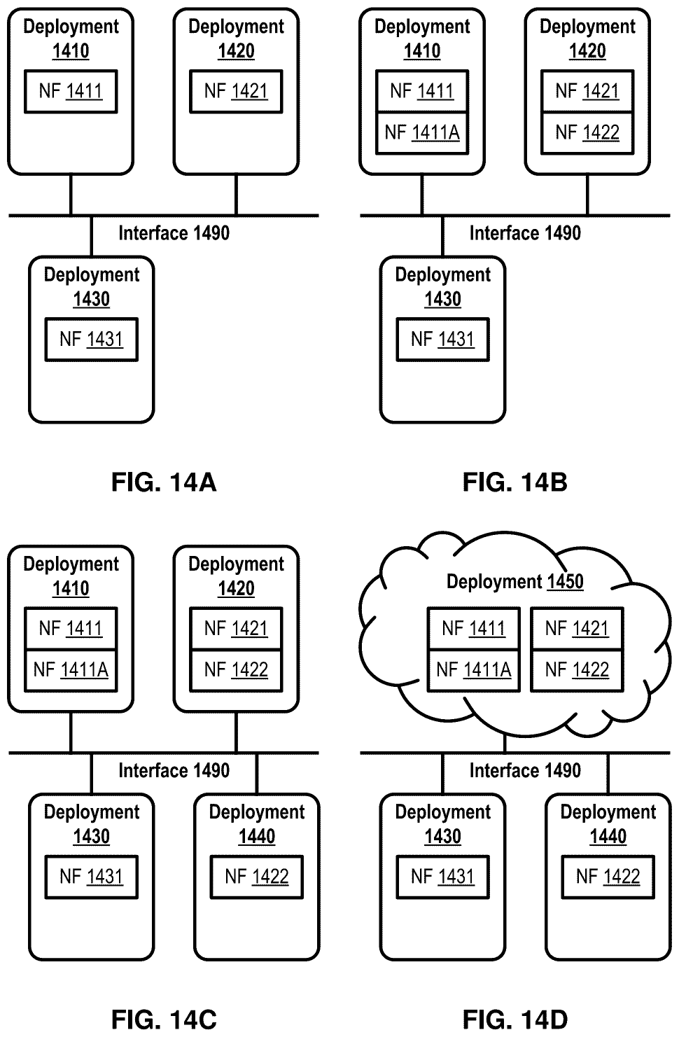

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

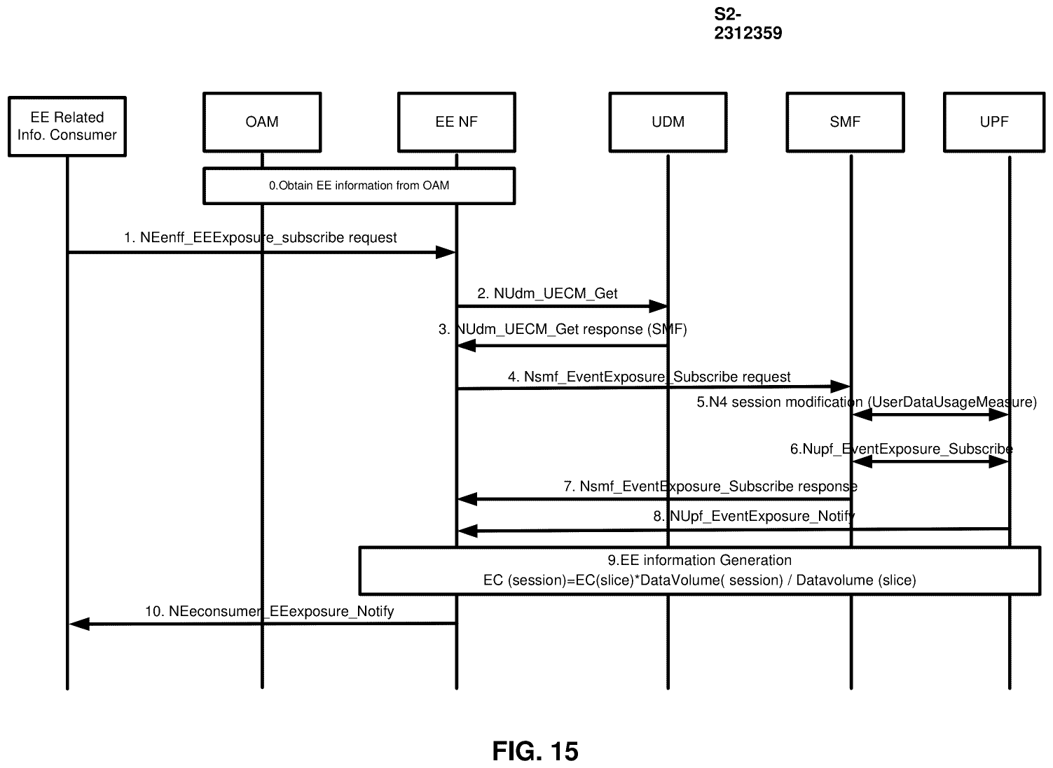

In an example embodiment as depicted in FIG. 15, OAM, network energy consumption may be mainly measured at the end-to-end network slice level, core network level, access network level or network function level, for core network part, a new interface between independent Energy Efficiency (EE) NF and OAM may be introduced to obtain energy related information at these granularities. EE NF may also obtain the data amount of one single PDU session through UPF event exposure service, then the calculation of PDU Session level granularity can be achieved suggesting the EE NF has already obtained network slice granularity or network function granularity energy related information (e.g. data volume transmitted through one single UPF related to one single network slice, energy consumption of one single network slice).

In an example, Energy Efficiency Network Function may obtain network slice granularity and network function granularity energy consumption from OAM. The energy exposure service consumer e.g., third parties request the 5GS to expose energy related information. The request may be provided through NEF. S-NSSAI, DNN, UE ID, etc. may be provided together with the exposure request. The request may also indicate what granularity of energy related information the consumer want. In an example, the EE NF may request the UDM to get the information of serving SMF for the UE/DNN/S-NSSAI through UDM_UECM_get service. The UDM may respond serving SMF information e.g., SMF Set ID or SMF IP address to EE NF. The EE NF may send a request to SMF to obtain the data volume of the existed PDU session related to the UE/S-NSSAI/DNN. Through UPF Exposure service, EE NF may obtain the data volume of the PDU session. Energy consumption or energy efficiency calculation may be performed.

The EE NF has obtained the E2E network slice EE and EC information from the OAM system. It will also have the total data volume (DV) of the E2E network slice e.g., sum of UL and DL data volumes at N3 interface(s) of the network slice.

The energy consumption for one single PDU session may be determined as follows:

$${EC}_{PDU} = \frac{{DV}_{PDU}}{{DV}_{n s}} \cdot {EC}_{n s}$$

The energy efficiency for one single PDU session may be determined as follows:

$${EE}_{PDU} = \frac{{DV}_{PDU}}{{DV}_{n s}} \cdot {EE}_{n s}$$

In an example embodiment, two energy saving states may be identified for cells, NEs and NFs. In an example, a cell or a network element (NE) or network function (NF) may be in one of these two states with respect to energy saving: notEnergySaving state and energySaving state.

In an example embodiment, the state of notEnergySaving state may indicate that the NF, NE, PDU session, S-NSSAI, QoS flow, UE, and/or the like are not subject to energy saving control or monitoring. In an example, the state of energySaving may indicate that the NF, NE, PDU session, S-NSSAI, QoS flow, UE, and/or the like are subject to energy saving control or monitoring. In an example embodiment, the state of energySaving state may trigger the network to configure a NE, NF, S-NSSAI, PDU session, QoS flow, UE to report energy consumption related events.

In an example, based on the above energy saving states, a full energy saving solution may comprise two elementary procedures:
Energy saving activation (change from notEnergySaving state to energySaving state)
Energy saving deactivation (change from energySaving state to notEnergySaving state)

In an example, when a NF, a NE or a cell is in energy saving state it may need candidate NEs, NFs, or cells to pick up the load. However, a NE, NF, or a cell in energySaving state may not cause an outage or coverage holes or create undue load on the surrounding cells. All traffic on that NE or cell is expected to be drained to other overlaid/umbrella candidate NEs or cells before the NE or cell moves to energySaving state.

A NE, NF, or a cell in energySaving state is not considered as a NE, NF, or a cell outage or a fault condition. No alarms should be raised for any condition that is a consequence of a subject cell or network element or network function moving into energySaving state.

In an example embodiment, energy saving states may comprise more than two energy saving states. In an example, a cell or a network element or network function may be on one of these states with respect to energy saving: notEnergySaving state, partial energy saving state, and energySaving state.

In an example, based on the above energy saving states, a full energy saving solution may comprise two elementary procedures:
Energy saving activation (change from notEnergySaving state to partial energySaving state or energySaving state)
Energy saving deactivation (change from partial energySaving state or energySaving state to notEnergySaving state)

In an example, when a NF, a NE or a cell is in energy saving state it may need candidate NEs, NFs, or cells to pick up the load. However, a NE, NF, or a cell in energySaving state may not cause coverage holes or create undue load on the surrounding cells. All traffic on that cell is expected to be drained to other overlaid/umbrella candidate cells before the cell moves to energySaving state.

A NE, NF, or a cell in energySaving state is not considered as a NE, NF, or a cell outage or a fault condition. No alarms should be raised for any condition that is a consequence of a subject cell or network element or network function moving into energySaving state.

The power and energy metering is mandatory as per Power, Energy and Environmental (PEE) principles described in ETSI ES 202 336-12 V1.2.1. In an example, the requirements for Power, Energy and Environmental (PEE) measurement may be applicable when a NF is deployed as a physical entity, virtual entity on a shared physical resource, and/or the like. In an example, a management service producer responsible for PEE measurement control may have the capability allowing its authorized consumer to request starting the collection of PEE measurement data of NE(s) or NF(s). In an example, the management service producer responsible for PEE measurement control may have the capability allowing its authorized consumer to indicate the reporting method, granularity period, reporting period, etc. for PEE measurement data of NE(s) or NF(s). The management service producer responsible for PEE measurement control may have the capability to generate the PEE measurement data of NE(s) or NF(s) according to the request of the consumer. The management service producer responsible for PEE measurement control may have the capability allowing its authorized consumer to request stopping the collection of PEE measurement data of NE(s) or NF(s). The management service producer responsible for PEE measurement control may have the capability allowing its authorized consumer to query the information about the ongoing collection of PEE measurement data of NE(s) or NF(s). The management service producer (e.g., the EMF, EE NF, NWDAF, EBF, and/or the like) responsible for PEE measurement control may have the capability of collecting the PEE measurement data of PNF(s) in the network (e.f., the NE(s) NF(s), gNB, and/or the like) according to the request of the consumer.

In an example embodiment, power and energy consumption measurement may comprise the following. The power is in Watt and the energy is the cumulated active energy metering in Wh or kWh at the input of the NF or Network Equipment. Considering the record period Tr, the physical expression of instant power P(t), power consumption E(Tr) and mean power P(Tr) over Tr are as follows: P(t)=u(t)·i(t) and E(t)=p(t)·Ta, Where u(t) and i(t) are values of voltage and current acquired over the Ta period by analog-digital conversion.

Existing technologies support registration of a UE and establishment of PDU sessions. In an example, network controlled energy consumption control may be implemented. A UE may establish a PDU session. After establishment of PDU session some network functions that serve the PDU session of the UE may change their state to energy saving mode or with restricted usage due to exceeding an energy consumption threshold. As a result, some QoS requirements may not be met.

Example embodiments of the present disclosure enhance signalling and policy control to update policy information when an energy saving state is activated or when energy consumption control is activated. In an example embodiment, a PCF receives an indication that energy consumption control is activated or deactivated. The PCF, in response to receiving the indication, provides policy information pertaining to SMF or AMF. Enhanced procedures may result in a proper allocation of resources when energy consumption control is activated. Furthermore, it helps in load balancing and properly redirecting the traffic.

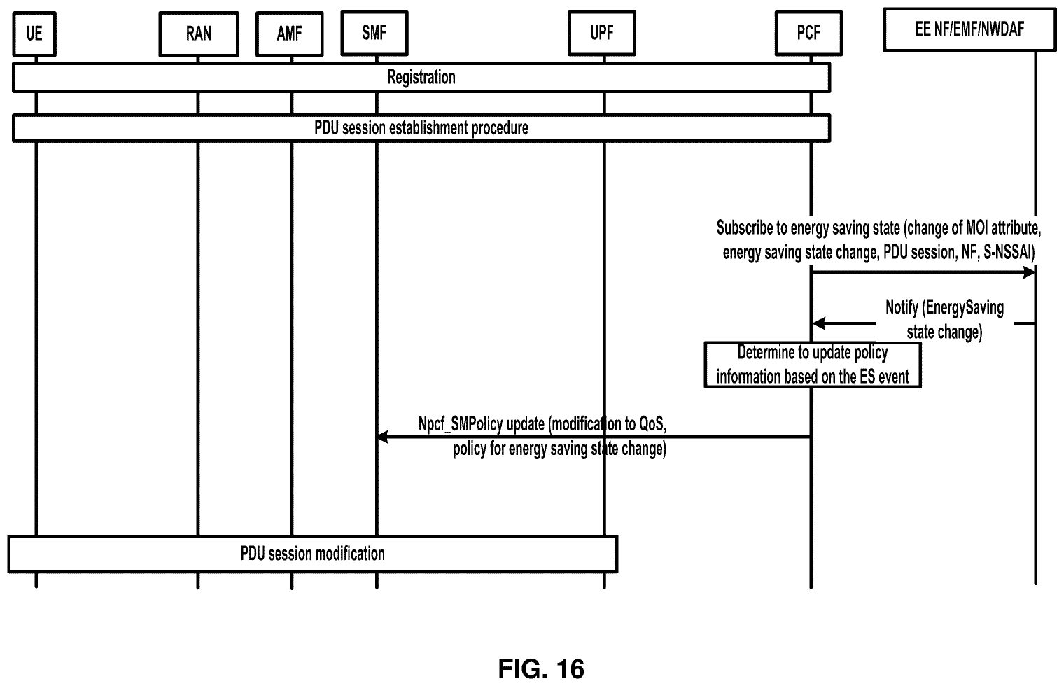

In an example, as depicted in FIG. 16, a UE may perform a registration procedure. Upon performing a registration procedure and receiving a registration accept message, the UE may perform a PDU session establishment procedure. In an example, as described in example embodiments, the AM policy association establishment and the SM policy association establishment may be performed. In an example, the PCF may trigger modification of the AM policy association or the SM policy association.

In an example, the PCF may receive a notification from a network entity that is for energy consumption and management of energy saving states. The network entity may be an analytics function, an NWDAF, an EMF, an EBF, an EE NF, and/or the like. In an example, the PCF may receive the notification in response to sending a subscription request message to the network entity (e.g., analytics function, the NWDAF, the EMF, the EBF, the EE NF, and/or the like). In an example, the subscription request message may be an Nnwdaf message, Nemf message, Nebf message, Neenf message, and/or the like. In an example, the subscription request message may comprise conditions for reporting an event to the PCF. In an example, the event may comprise the event that corresponds to energy consumption related events such as energy consumption exceeding a threshold. In an example, the energy consumption may be associated with the UE, the PDU session of the UE, a QoS flow of the UE, a QoS flow of the PDU session, a S-NSSAI, and/or the like. In an example, the event may be associated with a NF, or NE of the 3GPP network or the PLMN, SNPN, NPN, and/or the like.

In an example embodiment, the event may correspond to an energy saving status change such as a change in managed object instance (MOI) attribute (value) of a NE or a NF. In an example, the NF may correspond to the UE, the PDU session of the UE, a QoS flow of the UE, a QoS flow of the PDU session, a S-NSSAI, and/or the like. In an example embodiment, the MOI attribute may be associated with the PDU session of the UE, a QoS flow of the UE, a QoS flow of the PDU session, a S-NSSAI, and/or the like.

In an example, the PCF may provide updated policy information, e.g., AM policy information, SM policy information, and/or the like. In an example, the PCF may send to the SMF a Npcf_SMPolicyControl_Update response with updated policy information about the PDU Session. In an example, the PCF may send to the SMF the Npcf_SMPolicyControl_UpdateNotify request with possibly updated policy information about the PDU Session.

In an example embodiment, the PCF may receive a request to update policy. The request may be based on meeting a condition as determined by the policy control request trigger (PCRT). The PCRT may be provide to the SMF or the AMF. When the PCRT is provided to the SMF, the PCRT e.g., Policy Control Request (PCR) Triggers relevant for SMF may define the conditions when the SMF may interact again with PCF after a PDU Session establishment as defined in the Session Management Policy Establishment and Session Management Policy Modification procedures described in example embodiments. The PCR triggers may not be applicable any longer at termination of the SM Policy Association. The access independent Policy Control Request Triggers relevant for SMF are listed in the table below.

Access independent Policy Control Request Triggers relevant for SMF

| Policy Control Request | | Conditions for | |
|---|---|---|---|
| Trigger | Description | reporting | Motivation |
| Energy consumption of | EC level pertaining to resources | | |
| PDU session exceed a | associated with a PDU session exceed | | |
| threshold, the threshold | threshold. | | |
| value | | | |
| energy saving status | State of energy saving of the NF | | |
| (mode) of NF serving a | changed to ON or OFF. State of energy | | |
| PDU session | saving mode changed from/to partial | | |
| | to/from full. | | |
| Energy consumption of | EC level pertaining to resources | | |
| a NF exceed threshold, | associated with a NE/NF exceed | | |
| threshold value | threshold. | | |
| Energy consumption of | EC level pertaining to resources | | |
| a QoS flow, S-NSSAI, | associated with a QoS flow, S-NSSAI, | | |
| UE, Application ID | UE, Application ID exceed threshold. | | |
| exceed threshold, | | | |
| threshold value | | | |
| PLMN change | The UE has moved to another operators' | PCF | |
| | domain. | | |
| QoS change | The QoS parameters of the QoS Flow | | Only applicable when |
| | has changed. | | binding of bearers was |
| | | | done in PCRF. |
| QoS change exceeding | The QoS parameters of the QoS Flow | | Only applicable when |
| authorization | has changed and exceeds the | | binding of bearers was |
| | authorized QoS. | | done in PCRF. |
| Traffic mapping | The traffic mapping information of the | | Only applicable when |
| information change | QoS profile has changed. | | binding of bearers was |
| | | | done in PCRF. |
| Resource modification | A request for resource modification has | SMF always reports | |
| request | been received by the SMF. | to PCF | |
| Routing information | The IP flow mobility routing information | | Not in 5GS yet. |
| change | has changed (when IP flow mobility as | | |
| | specified in TS 23.261 [11] applies) or | | |
| | the PCEF has received Routing Rules | | |
| | from the UE (when NBIFOM as specified | | |
| | in TS 23.161 [10] applies). | | |
| Change in Access | The Access Type and, if applicable, the | PCF | |
| Type (NOTE 8) | RAT Type of the PDU Session has | | |
| | changed. | | |
| EPS Fallback | EPS fallback is initiated | PCF | |
| Loss/recovery of | The Access type transmission resources | | Not in 5GS yet. |
| transmission resources | are no longer usable/again usable. | | |
| Location change | The serving cell of the UE has changed. | PCF | |
| (serving cell) (NOTE 6) | | | |
| Location change | The serving area of the UE has | PCF | |
| (serving area) (NOTE 2) | changed. | | |
| Location change | The serving core network node of the UE | PCF | |
| (serving CN node) (NOTE 3) | has changed. | | |
| Change of UE presence | The UE is entering/leaving a Presence | PCF | Only applicable to |
| in Presence Reporting | Reporting Area. | | PCF |
| Area (see NOTE 1) | | | |
| Out of credit | Credit is no longer available. | PCF | |
| Reallocation of credit | Credit has been reallocated after the | PCF | |
| | former Out of credit indication. | | |
| Enforced PCC rule | SMF is performing a PCC rules request | PCF | |
| request | as instructed by the PCF. | | |
| Enforced ADC rule | TDF is performing an ADC rules request | | ADC Rules are not |
| request | as instructed by the PCRF. | | applicable. |
| UE IP address change | A UE IP address has been | SMF always reports | |
| | allocated/released. | allocated or | |
| | | released UE IP | |
| | | addresses | |
| UE MAC address | A new UE MAC address is detected or a | PCF | |
| change | used UE MAC address is inactive for a | | |
| | specific period. | | |
| Access Network | Access Network Charging Correlation | PCF | |
| Charging Correlation | Information has been assigned. | | |
| Information | | | |
| Usage report (NOTE 4) | The PDU Session or the Monitoring key | PCF | |
| | specific resources consumed by a UE | | |
| | either reached the threshold or needs to | | |
| | be reported for other reasons. | | |
| Start of application traffic | The start or the stop of application traffic | PCF | |
| detection and | has been detected. | | |
| Stop of application traffic | | | |
| detection (NOTE 5) | | | |
| SRVCC CS to PS | A CS to PS handover has been | | No support in 5GS yet |
| handover | detected. | | |
| Access Network | Access information as specified in the | PCF | |
| Information report | Access Network Information Reporting | | |
| | part of a PCC rule. | | |
| Credit management | Transient/Permanent failure as specified | PCF | |
| session failure | by the CHF. | | |
| Addition/removal of an | The PCEF reports when an access is | | No support in 5GS yet |
| access to an IP-CAN | added or removed. | | |
| session | | | |
| Change of usability of an | The PCEF reports that an access | | No support in 5GS yet |
| access | becomes unusable or usable again. | | |
| 3GPP PS Data Off | The SMF reports when the 3GPP PS | SMF always reports | |
| status change | Data Off status changes. | to PCF | |
| Session AMBR change | The Session-AMBR has changed. | SMF always reports | |
| | | to PCF | |
| Default QoS change | The subscribed QoS has changed. | SMF always reports | |
| | | to PCF | |
| Removal of PCC rule | The SMF reports when the PCC rule is | SMF always reports | |
| | removed. | to PCF | |
| Successful resource | The SMF reports to the PCF that the | PCF | |
| allocation | resources for a PCC rule have been | | |
| | successfully allocated. | | |
| GFBR of the QoS Flow | The SMF notifies the PCF when | | |
| can no longer (or can | receiving notifications from RAN that | | |
| again) be guaranteed | GFBR of the QoS Flow can no longer (or | | |
| | can again) be guaranteed. | | |
| UE resumed from | The SMF reports to the PCF when it | PCF | Only applicable to |
| suspend state | detects that the UE is resumed from | | EPC IWK |
| | suspend state. | | |
| Change of DN | The DN Authorization Profile Index | SMF always reports | |
| Authorization Profile | received from DN-AAA has changed. | to PCF | |
| Index | | | |
| 5GS Bridge/Router | SMF has detected new 5GS | PCF | |
| information available | Bridge/Router information, which may | | |
| | contain, user-plane Node ID, UE-DS-TT | | |
| | residence time and Ethernet port (port | | |
| | number and MAC address) or IP | | |
| | address for the PDU Session, MTU size | | |
| | for IPv4 or MTU size for IPv6 and/or | | |
| | PMIC and/or UMIC. | | |
| QoS Monitoring | The SMF notifies the PCF of the QoS | PCF | |
| | Monitoring reports (as defined in | | |
| | clause 5.45 of TS 23.501 [2]). | | |
| DDN Failure event | The SMF requests PCF to provide or | PCF | |
| Subscription with Traffic | remove policies if it received an event | | |
| Descriptor | subscription or cancellation for DDN | | |
| | Failure event including traffic descriptors. | | |
| | The SMF provides the traffic descriptors | | |
| | to the PCF for policy evaluation. | | |
| DDD Status event | The SMF requests PCF to provide or | PCF | |
| Subscription with Traffic | remove policies if it received an event | | |
| Descriptor | subscription or cancellation for DDD | | |
| | Status event including traffic descriptors. | | |
| | The SMF provides the traffic descriptors | | |
| | and the requested type(s) of notifications | | |
| | (notifications about downlink packets | | |
| | being buffered, and/or discarded) to the | | |
| | PCF for policy evaluation. | | |
| QoS constraints change | The QoS constraints in the VPLMN have | SMF always reports | |
| | been provided or changed. | to PCF | |
| Satellite backhaul | The backhaul is changed between | PCF | |
| category change | different satellite backhaul categories, or | | |
| | between satellite backhaul and non- | | |
| | satellite backhaul. | | |
| NWDAF info change | The NWDAF instance IDs used for the | PCF | |
| | PDU session or associated Analytics IDs | | |
| | used for the PDU session and available | | |
| | in the SMF have changed. | | |
| Request for notification | The SMF reports to the PCF the request | PCF | |
| on SM Policy | to notify on the established or terminated | | |
| Association | SM Policy Association. | | |
| establishment or | | | |
| termination (NOTE 9) | | | |
| Notification on BAT | The SMF reports the BAT offset and | PCF | |
| offset | optionally the adjusted periodicity | | |
| | provided by the RAN. | | |
| UE reporting Connection | The SMF has received from the UE | PCF | |
| Capabilities from | reporting from an associated URSP rule | | |
| associated URSP | via a PDU session establishment or PDU | | |
| rule (NOTE 10) | session modification request. | | |
| UE Policy Container | The SMF reports that a UE Policy | SMF always reports | |
| received | Container has been received from the | to PCF | |
| | UE. | | |
| Change of HR-SBO | The HR-SBO support indication has | | |
| support indication | changed. | | |
| Network Slice | The SMF reports the event of change | PCF | |
| Replacement | between S-NSSAI and Alternative S- | | |
| | NSSAI to PCF when the SMF | | |
| | determines that the PDU Session and | | |
| | SM Policy Association can be retained. | | |
| | The SMF provides Alternative S-NSSAI | | |
| | when the PDU Session is transferred | | |
| | from S-NSSAI to Alternative S-NSSAI. | | |
| ECN marking for L4S | The SMF notifies the PCF when ECN | PCF | |
| can no longer (or can | marking for L4S can no longer (or can | | |
| again) be performed | again) be performed. | | |

In an example, the Policy Control Request Triggers (PCRT) relevant for AMF are depicted in the tables below and define the conditions when the AMF shall interact again with PCF after the AM Policy Association Establishment or UE Policy Association Establishment. In an example, the PCF provides Policy Control Request Triggers to the AMF indicating a specific UE (i.e. SUPI or PEI) in the Policy Association establishment and modification procedures. The Policy Control Request Triggers may be transferred from the old AMF to the new AMF when the AMF changes.

Policy Control Request Triggers relevant for AMF and 3GPP access type

| Policy Control | | Condition for |
|---|---|---|
| Request Trigger | Description | reporting |
| Energy consumption | EC level pertaining to resources associated with a S-NSSAI | |
| of S-NSSAI exceed a | exceed threshold. | |
| threshold | | |
| energy saving status | State of energy saving of the S-NSSAI changed to ON or OFF. | |
| (mode) change of a S- | State of energy saving mode changed from/to partial to/from full. | |
| NSSAI | | |
| Location change | The tracking area of the UE has changed. | PCF (AM Policy |
| (tracking area) | | Association, UE Policy |
| | | Association) |
| Change of UE | The UE is entering/leaving a Presence Reporting Area. | PCF (AM Policy |
| presence in Presence | | Association, UE Policy |
| Reporting Area | | Association) |
| Service Area | The subscribed service area restriction information has changed. | PCF (AM Policy |
| restriction change | | Association) |
| RFSP index change | The subscribed RFSP index has changed. | PCF (AM Policy |
| | | Association) |
| Change of the Allowed | The Allowed NSSAI has changed. | PCF (AM Policy |
| NSSAI | | Association) |
| Generation of Target | The Target NSSAI has been generated. | PCF (AM Policy |
| NSSAI | | Association) |
| Change of Partially | The Partially Allowed NSSAI has changed. | PCF (AM Policy |
| Allowed NSSAI | | Association) |
| Change of S-NSSAI(s) | The S-NSSAI(s) rejected partially in the RA has changed. | PCF (AM Policy |
| rejected partially in the | | Association) |
| RA | | |
| Change of rejected S- | The rejected S-NSSAI(s) for the RA has changed. | PCF (AM Policy |
| NSSAI(s) | | Association) |
| Change of Pending | The Pending NSSAI has changed. | PCF (AM Policy |
| NSSAI | | Association) |
| Configured NSSAI | The Configured NSSAI has changed. | PCF (UE Policy |
| change | | Association) |
| UE-AMBR change | The subscribed UE-AMBR has changed. | PCF (AM Policy |
| | | Association) |
| UE-Slice-MBR change | The subscribed UE-Slice-MBR has changed. | PCF (AM Policy |
| | | Association) |
| PLMN change | The UE has moved to another operators' domain. | PCF (UE Policy |
| | | Association) |
| SMF selection | UE request for an unsupported DNN or UE request for a DNN | PCF (AM Policy |
| management | within the list of DNN candidates for replacement per S-NSSAI. | Association) |
| Slice replacement | The AMF cannot determine the Alternative S-NSSAI for an S- | PCF (AM Policy |
| management | NSSAI. | Association) |
| Connectivity state | The connectivity state of UE is changed. | PCF (UE Policy |
| changes | | Association) |
| NWDAF info change | The NWDAF instance IDs used for the UE or associated | PCF (AM Policy |
| | Analytics IDs used for the UE and available in the AMF have | Association) |
| | changed. | |
| Satellite backhaul | Satellite backhaul category changes between any satellite | PCF (UE Policy |
| category change | backhaul categories (e.g. GEO, MEO, LEO, OTHERSAT), or | Association) |
| | between satellite backhaul and non-satellite backhaul. | |
| LBO Information | LBO Information (i.e. DNN(s) and/or S-NSSAI(s) that are allowed | PCF (UE Policy |
| change | for LBO in VPLMN in SMF Selection Data) has changed. | Association) |

Policy Control Request Triggers relevant for
AMF and both 3GPP and Non 3GPP access type

| Policy Control | | Condition for |
|---|---|---|
| Request Trigger | Description | reporting |
| Access Type | The Access Type has | PCF (UE Policy |
| change | changed, added, or removed. | Association) |

Policy Control Request Triggers relevant
for AMF and Non 3GPP access type

| Policy Control | | Condition for |
|---|---|---|
| Request Trigger | Description | reporting |
| wrong non- | UE has connected to a wrong non- | Always report |
| 3GPP access | 3GPP access that does not match | |
| | its subscribed S-NSSAI(s). | |

In an example, the access and mobility management (AM) Policy Association Establishment may comprise the following three cases: 1) UE initial registration with the network, 2) the AMF re-allocation with PCF change in handover procedure and registration procedure, 3) EPS to 5GS mobility when there is no existing AM Policy Association between AMF and PCF for this UE. In an example, the procedure for AM Policy Association Establishment with new Selected PCF may comprise the following. Based on local policies, the AMF may determine/decide to establish AM Policy Association with the (V-)PCF. If the AMF has not yet obtained access and mobility related policy information for the UE or if the access and mobility related policy information in the AMF is no longer valid, the AMF may request the PCF to apply operator policies for the UE from the PCF. The AMF may send Npcf_AMPolicyControl_Create to the (V-)PCF to establish an AM Policy Association with the (V-)PCF. The request may comprise the following information: SUPI, Internal Group, subscription notification indication and if available, Service Area Restrictions, RFSP index, Subscribed UE-AMBR, List of Subscribed UE-Slice-MBR, the Allowed NSSAI, Partially Allowed NSSAI, Target NSSAI, GPSI which are retrieved from the UDM during the update location procedure and may comprise Access Type and RAT Type, PEI, ULI, UE time zone and Serving Network (PLMN ID, or PLMN ID and NID. When AMF utilizes energy management function (EMF), energy efficiency network function (EE NF), energy brokerage function (EBF), and/or the like, it may add the EMF, EE NF, EBF serving the UE identified by the EMF instance ID, EE NF instance ID, EBF instance ID, and/of the like. When AMF utilizes an NWDAF, it may add the NWDAF serving the UE identified by the NWDAF instance ID. Per NWDAF service instance the Analytics ID(s) are also included.

In non-roaming case, if the PCF determines that the policy decision depends on the status of the policy counters available at the CHF and such reporting is not established for the subscriber, the PCF initiates an Initial Spending Limit Report Retrieval. If policy counter status reporting is already established for the subscriber and the PCF determines that the status of additional policy counters is required, the PCF initiates an Intermediate Spending Limit Report Retrieval.

The (V)-PCF may respond to the Npcf_AMPolicyControl_Create service operation. The (V)-PCF may provide access and mobility related policy information (e.g. Service Area Restrictions). In addition, (V)-PCF can provide Policy Control Request Trigger of AM Policy Association to AMF. In the non-roaming case, the PCF may subscribe to Analytics from NWDAF, the EMF, EE NF, EBF, and/or the like. The AMF may implicitly subscribed in the (V-)PCF to be notified of changes in the policies. The (V-)PCF may register to the BSF as the PCF that handles the AM Policy Association for this UE. This is performed by using the Nbsf_Management_Register operation, providing as inputs the UE SUPI/GPSI and the PCF identity. The AMF may deploy the access and mobility related policy information which includes storing the Service Area Restrictions and Policy Control Request Trigger(s) of the AM Policy Association, provisioning Service Area Restrictions to the UE and provisioning the RFSP index, the UE-AMBR, List of UE-Slice-MBR, Service Area Restrictions to the NG-RAN and request for notification of SM Policy association establishment and termination to a list of (DNN, S-NSSAI) (s) together with PCF for the UE binding information.

In an example, AM Policy Association Modification may be performed in the following cases. Case A: A Policy Control Request Trigger condition is met: the procedure is initiated by the AMF. Case B: PCF policy decision per local decision or per trigger by other peers of the PCF (i.e. UDR, AF or NWDAF): the procedure is initiated by the PCF. Case C: AM Policy Association Modification with the old PCF during AMF relocation: the procedure is initiated by the AMF.

In the non-roaming case, the PCF may interact with the CHF to make policy decisions, for Access and Mobility related policies, based on spending limits.

In an example, when a Policy Control Request Trigger condition is met the AMF updates the AM Policy Association and provides information on the conditions that have changed to the PCF by invoking Npcf_AMPolicyControl_Update. The (V-)PCF may store the information received and may make the policy decision. In the non-roaming case, the PCF may subscribe to Analytics from NWDAF. In an example, the PCF may subscribe to energy consumption related events to EMF, EE NF, EBF, and/or the like. If the PCF determines a change to policy counter status reporting is required, it may alter the subscribed list of policy counters using the Initial, Intermediate or Final Spending Limit Report Retrieval procedures.

The (V-)PCF may respond to the AMF with the updated access and mobility related policy information and the updated Policy Control Request Trigger parameters. If an AF has previously subscribed to request for allocation of service area coverage outcome event, the (V-)PCF checks if reporting is needed, using the Policy Control Request Trigger that was met as input, then sends a respective notification to the AF using Npcf_AMPolicyAuthorization_Notify.

The AMF may deploy the access and mobility related policy information, which includes storing the Service Area Restrictions and Policy Control Request Trigger of AM Policy Association, provisioning the Service Area Restrictions to the UE and provisioning the RFSP index, UE-AMBR, List of UE-Slice-MBR, Service Area Restrictions to the NG-RAN and request for notification of SM Policy association establishment and termination to a list of (DNN, S-NSSAI) (s) together with PCF for the UE binding information.

In an example, the AM Policy Association modification procedure may be initiated by an internal PCF event or by PCF obtaining pertinent analytics information from an NWDAF, EMF, EE NF, EBF, and/or the like.

In an example, the PCF may determine internally that the new status of the UE context requires new policies, potentially triggered by an AF, EMF, EE NF, EBF, and/or the like or by a notification from the UDR or, the CHF provides a Spending Limit Report to the PCF. This may be triggered by obtaining pertinent analytics information from an NWDAF, EMF, EE NF, EBF, and/or the like. The (V-)PCF in case of roaming and PCF in a non-roaming case make a policy decision. The PCF may also decide to subscribe to a new Analytics ID from NWDAF, EMF, EE NF, EBF, and/or the like.

The (V-)PCF in the roaming case and the PCF in a non-roaming case may send Npcf_AMPolicyControl_UpdateNotify including AM Policy Association ID associated with the SUPI. The policy update may include Service Area Restrictions, UE-AMBR, RESP index value and RFSP in Use Validity Time, access stratum time distribution indication, Uu time synchronization error budget, clock quality detail level and optionally clock quality acceptance criteria. If an AF has previously subscribed to event request for allocation of service area coverage outcome in step 1, the (V-)PCF checks if the allocated service area coverage was changed and sends a respective notification to the AF using Npcf_AMPolicyAuthorization_Notify.

The AMF may deploy and stores the updated access and mobility related policy information, which includes storing the Service Area Restrictions and Policy Control Request Trigger of AM Policy Association, provisioning of the Service Area Restrictions to the UE, provisioning the RFSP index, UE-AMBR, Service Area Restrictions to the NG-RAN, optionally the access stratum time distribution indication, Uu time synchronization error budget, clock quality detail level and optionally clock quality acceptance criteria to the NG-RAN and request for notification of SM Policy association establishment and termination to a list of (DNN, S-NSSAI) (s) together with PCF for the UE binding information.

In an example embodiment, during a PDU session establishment procedure, PDU session modification procedure, service request procedure, registration procedure, and/or the like, the SMF may perform an SM Policy Association Establishment procedure to establish an SM Policy Association with the PCF and get the default PCC Rules for the PDU Session. The GPSI, PVS FQDN(s) and/or PVS IP address(es) and the Onboarding Indication may be included if available at SMF in the case of ON-SNPN. If the Request Type indicates “Existing PDU Session”, the SMF may provide information on the Policy Control Request Trigger condition(s) that have been met by an SMF initiated SM Policy Association Modification procedure. The PCF may provide policy information to SMF. The URSP rule enforcement may be included if SMF receives the URSP rule enforcement from UE. The PCF for the UE subscribes to notifications of event “UE reporting Connection Capabilities from associated URSP rule”, using Npcf_PolicyAuthorization_Subscribe (EventId set to “UE reporting Connection Capabilities from associated URSP rule”, EventFilter set to at least “list of Connection Capabilities”) to the PCF for the PDU Session. The PCF for session may notify the PCF for UE about the URSP rule enforcement together with the PDU session parameters that this application associated with by Npcf_PolicyAuthorization_Notify.

During the SM Policy Association Establishment procedure, if the PCF detects the request relates to SM Policy Association for a PDU session of a UE that supports network controlled energy saving, the PCF may provide policy control request trigger to network functions such as SMF, AMF, EMF, EE NF, NWDAF, and/or the like.

During the SM Policy Association Establishment procedure, if the PCF detects the request relates to SM Policy Association enabling integration with TSN or TSC or Deterministic Networking based on local configuration, the PCF may provide policy control request trigger for 5GS Bridge/Router Information.

In an example, the PCC rules may be employed for UPF selection. For example, the PCC rule may indicate selection of a NF such as UPF, if renewable energy is used. For example, a preference of the UE or the PCC rule may prioritize resources that consume renewable energy, green energy, and/or the like. In an example, the PCC rule may indicate that the UPF selection may be based on support of PEE measurement control functionality. For example, if the UPF or a NF is responsible for PEE measurement control, the NF or the UPF may have the capability of collecting the PEE measurement data. In an example, the UPF may report the capability of collecting the PEE measurement data to the SMF via N4 interface, N4 association message, PFCP association message, and/or the like. In an example, the UPF may report the capability of collecting the PEE measurement data to the NRF via Nnrf NF registration procedure. The UPF or the NE/NF may employ Nnrf register message that may comprise the NF ID, NE ID, the capability of collecting the PEE measurement data indication, and/or the like.

During the SM Policy Association Establishment procedure for a non-roaming PDU Session, if a S-NSSAI is subject to network slice usage control, the PCF may provide a Slice Usage Policy information including whether a network slice is on demand and a PDU Session inactivity timer value. In an example, during the SM Policy Association Establishment procedure for a PDU session, if a S-NSSAI is subject to network slice energy consumption control, the PCF may provide a slice policy information including whether a network slice usage is restricted due to energy consumption control by the network. In an example, the PCF may provide a PDU session timer value. In an example, the PDU session timer value may indicate a time duration for which the PDU session may not use the S-NSSAI.

In an example, the SM policy association establishment procedure may comprise the following. The SMF may determine that the PCC authorization is required and may request to establish an SM policy association with the PCF by invoking Npcf_SMPolicyControl_Create operation, including information about the PDU Session. The SMF may provide trace requirements to the PCF when it has received trace requirements and it has selected a different PCF than the one received from the AMF. If the DNN Selection Mode indicates that the DNN is not explicitly subscribed, the PCF may use the local configuration instead of PDU Session policy control data in UDR. The QoS constraints from the VPLMN may be provided by the H-SMF to the H-PCF in the home routed roaming scenario. If the SMF utilizes an NWDAF or in case the SMF has received information from AMF or UPF that are consumer of analytic services, the SMF includes the IDs of each of these NWDAFs serving the UE (for SMF, AMF and UPF), identified by the NWDAF instance Id. The Analytics ID(s) are also included per NWDAF service instance. If the SMF utilizes an NWDAF, energy management function (EMF), energy efficiency network function (EE NF), energy brokerage function (EBF), and/or the like or in case the SMF has received information from AMF or UPF that are consumer of analytic services, energy management functions (e.g., EMF, EE NF, EBF, etc.), the SMF may include the IDs of each of these NFs serving the UE (for SMF, AMF and UPF), identified by the NWDAF, EMF, EE NF, EBF instance Id. The Analytics ID(s) are also included per NWDAF, EMF, EE NF, EBF service instance.

In an example, the SMF may provide the request for notification of SM Policy Association establishment and termination to a DNN, S-NSSAI together with PCF for the UE binding information to the PCF if received from the AMF. In an example, if the PCF does not have the subscriber's subscription related information, it may send a request to the UDR by invoking Nudr_DM_Query (SUPI, DNN, S-NSSAI, Policy Data, PDU Session policy control data, Remaining allowed Usage data) service in order to receive the information related to the PDU session. The PCF may request notifications from the UDR on changes in the subscription information by invoking Nudr_DM_Subscribe (Policy Data, SUPI, DNN, S-NSSAI, Notification Target Address (+Notification Correlation Id), Event Reporting Information (continuous reporting), PDU Session policy control data, Remaining allowed Usage data) service. In an example, if the PCF determines that the policy decision depends on the status of the policy counters available at the CHF and such reporting is not established for the subscriber, the PCF initiates an Initial Spending Limit Report Retrieval. If policy counter status reporting is already established for the subscriber and the PCF determines that the status of additional policy counters are required, the PCF may initiate an Intermediate Spending Limit Report Retrieval. In an example, the PCF may make the authorization and the policy decision. The PCF may reject Npcf_SMPolicyControl_Create request when Validation condition is not satisfied. The PCF may invoke Nbsf_Management_Register service operation to create the binding information in BSF. The PCF may report that a SM Policy Association is established. In the non-roaming case, the PCF may subscribe to analytics from NWDAF. In the home-routed roaming scenario, the H-PCF may ensure that the QoS constraints provided by the VPLMN are taken into account. In an example, the PCF may answer with a Npcf_SMPolicyControl_Create response; in its response the PCF may provide policy information as described in example embodiments.

In an example, the SMF may enforce the decision (e.g., policy decision received from the PCF). The SMF may implicitly subscribe to changes in the policy decisions. In an example, the PCF may subscribe to SMF events associated with the PDU Session. In an example, the event may correspond to energy consumption related events such as energy consumption exceeds a threshold. In an example, the energy consumption may be associated with the UE, the PDU session of the UE, a QoS flow of the UE, a QoS flow of the PDU session, a S-NSSAI, and/or the like. In an example, the event may correspond to an energy saving status change such as a change in managed object instance (MOI) attribute (value) of a NF. In an example, the NF may correspond to the UE, the PDU session of the UE, a QoS flow of the UE, a QoS flow of the PDU session, a S-NSSAI, and/or the like. In an example embodiment, the MOI attribute may be associated with the PDU session of the UE, a QoS flow of the UE, a QoS flow of the PDU session, a S-NSSAI, and/or the like.

In an example, the SM Policy Association Modification procedure may comprise the following. When the Policy Control Request Trigger condition is met, the SMF requests to update (Npcf_SMPolicyControl_Update) the SM Policy Association and provides information on the conditions that have been met. In an example, the information of the condition may correspond to energy consumption related events such as energy consumption exceeding a threshold e.g., an event is triggered. In an example, the energy consumption may be associated with the UE, the PDU session of the UE, a QoS flow of the UE, a QoS flow of the PDU session, a S-NSSAI, and/or the like. In an example, the information of the condition may correspond to an energy saving status change such as a change in managed object instance (MOI) attribute (value) of a NF. In an example, the NF may correspond to the UE, the PDU session of the UE, a QoS flow of the UE, a QoS flow of the PDU session, a S-NSSAI, and/or the like. In an example embodiment, the MOI attribute (value) may be associated with the PDU session of the UE, a QoS flow of the UE, a QoS flow of the PDU session, a S-NSSAI, and/or the like.

In an example, if the SMF is notified by NRF that the stored PCF instance is not reachable, it may query the NRF for PCF instances within the PCF set and select another instance. In an example, the QoS constraints from the VPLMN may be provided by the H-SMF to the H-PCF in the home routed roaming scenario.

In an example, the PCF may receive a notification of an event from an NWDAF, EMF, EE NF, EBF, and/or the like. In an example, the event may be an energy consumption related event such as energy consumption exceeding a threshold. In an example, the energy consumption may be associated with the UE, the PDU session of the UE, the QoS flow of the UE, the QoS flow of the PDU session, the S-NSSAI, and/or the like. In an example, the event may be a change of state such as an energy saving status change e.g., a change in managed object instance (MOI) attribute (value) of the NF. In an example, the NF may correspond to the UE, the PDU session of the UE, the QoS flow of the UE, the QoS flow of the PDU session, the S-NSSAI, and/or the like. In an example embodiment, the MOI attribute may be associated with the PDU session of the UE, the QoS flow of the UE, the QoS flow of the PDU session, the S-NSSAI, and/or the like.

In an example, if the PCF determines a change to policy counter status reporting is required, it may alter the subscribed list of policy counters using the Initial, Intermediate or Final Spending Limit Report Retrieval procedures. In an example, the PCF may make a policy decision. The PCF may determine that updated or new policy information needs to be sent to the SMF. If the SMF reported accumulated usage for the PDU session, the PCF deducts the value from the remaining allowed usage for the subscriber, DNN and S-NSSAI in the UDR by invoking Nudr_DM_Update (SUPI, DNN, S-NSSAI, Policy Data, Remaining allowed Usage data, updated data) service operation. If the SMF reported accumulated usage for a MK(s) the PCF deducts the value from the remaining allowed usage for the MK in the UDR by invoking Nudr_DM_Update (SUPI, DNN, S-NSSAI, Policy Data, Remaining allowed Usage data, updated data (including MK(s))) service operation. When new PCF instance is selected, the new PCF may invoke Nbsf_Management_Update service operation to update the binding information in BSF.

In the non-roaming case, the PCF may subscribe to Analytics from NWDAF the EMF, the EE NF, the EBF, and/or the like. In the home-routed roaming scenario, the H-PCF ensures that the QoS constraints provided by the VPLMN are taken into account. In an example, the PCF may respond/answer with a Npcf_SMPolicyControl_Update response with updated policy information about the PDU Session.

In an example, the PCF initiated SM policy association modification may comprise the following. This procedure may be triggered by a local decision of the PCF or based on triggers from other peers of the PCF (the EMF, the EE NF, the EBF, AF, NWDAF, CHF, UDR and TSCTSF). In an example, an SM Policy Association may be established, with the PCF as described in an example embodiment. In local breakout roaming, the V-PCF may interact with the UDR of the VPLMN. In an example, the EMF, the EE NF, the EBF, the AF, NEF or TSCTSF may provide/revoke service information to the PCF e.g. due to AF session signalling, by invoking Npcf_PolicyAuthorization_Create Request or Npcf_PolicyAuthorization_Update Request or Npcf_PolicyAuthorization_Subscribe Request service operation. The PCF may respond to the EMF, the EE NF, the EBF, the AF, NEF or TSCTSF.

In an example, the UDR may notify the PCF about a policy subscription change by invoking Nudr_DM_Notify (Notification correlation Id, Policy Data, SUPI, updated data, “PDU Session Policy Control Data” | “Remaining allowed Usage data”); The PCF responds to the UDR.

In an example, some internal event (e.g. timer, or local decision based on analytics information requested and received from the EMF, the EE NF, the EBF, the NWDAF) occurs at the PCF. The analytics (e.g., Analytics ID) may be requested from the EMF, the EE NF, the EBF, the NWDAF.

In an example, if the PCF determines a change to policy counter status reporting is required, it may alter the subscribed list of policy counters using the Initial, Intermediate or Final Spending Limit Report Retrieval procedures.

In an example, the PCF may makes a policy decision. The PCF may determine that updated or new policy information may need to be sent to the SMF or AMF. In the non-roaming case, the PCF may decide to subscribe to a new Analytics ID from the EMF, the EE NF, the EBF, the NWDAF, and/or the like.

In an example, if the AF provided a Background Data Transfer Reference ID, the PCF may retrieve it from the UDR by invoking the Nudr_DM_Query (BDT Reference Id, Policy Data, Background Data Transfer) service. If the PCF has determined that SMF needs updated policy information or if the PCF has received a Port Management Information Container for the PDU Session and related port number from the AF or TSCTSF, the PCF issues a Npcf_SMPolicyControl_UpdateNotify request with possibly updated policy information about the PDU Session.

If the PCF has received a subscription for 5GS Bridge/Router information Notification in Step 1a, the PCF can include a subscription for SMF event for “5GS Bridge/Router information” associated with the PDU Session into the Npcf_SMPolicyControl_UpdateNotify request. In this case, if the SMF has stored the 5GS Bridge/Router information and has not reported the event to the PCF, the SMF notifies the PCF for the event of “5GS Bridge/Router Information”.

If the PCF has received a Npcf_PolicyAuthorization_Unsubscribe request to unsubscribe for 5GS Bridge/Router information Notification, the PCF can remove the subscription for SMF event for “5GS Bridge/Router information” associated with the PDU Session and issue a Npcf_SMPolicyControl_UpdateNotify request with the updated policy information about the PDU Session.

If the PCF has received a subscription to notification on BAT offset along with the TSC Assistance Container from TSCTSF in step 1a, the PCF can include a subscription to notification on BAT offset associated with the PDU Session into the Npcf_SMPolicyControl_UpdateNotify request.

In an example, the SMF may acknowledge the PCF request with a Npcf_SMPolicyControl_UpdateNotify response. If the Npcf_SMPolicyControl_UpdateNotify request is received from new PCF instance in the PCF Set, the SMF may store the SM policy association towards the new PCF instance.

In an example embodiment, UE Policy Association Modification initiated by the PCF may comprise the following. This procedure is used to update UE policy and/or UE policy triggers.

In the non-roaming case, the H-PCF may interact with the CHF in HPLMN to make a decision about UE Policies based on spending limits. If (H-)PCF subscribed to notification of subscriber's policy data change or 5G VN Group Configuration (5G VN group data, 5G VN group membership) change and a change is detected, the UDR notifies that the subscriber's policy data of a UE or 5G VN Group Configuration (5G VN group data, 5G VN group membership) has been changed. In an example, the UDR may notify the (H-)PCF of the updated policy control subscription information profile via Nudr_DM_Notify (Notification correlation Id, Policy Data, either UE context policy control data or Policy Set Entry data or both, SUPI), or the UDR notifies the (H-)PCF of the updated 5G VN Group Configuration (5G VN group data, 5G VN group membership) via Nudr_DM_Notify (Notification correlation Id, 5G VN Group Configuration, Internal-Group-Identifier), or The (V-)UDR notifies the (V-)PCF of the updated policy control subscription information profile via Nudr_DM_Notify (Notification correlation Id, Policy Data, PolicySetEntry Data. PLMN ID). The (V-)UDR notifies the (V-)PCF of the updated Service Parameters via Nudr_DM_Notify. The PCF may determine locally that UE policy information needs to be sent to the UE. The CHF notifies the (H-)PCF about the change of the status of the subscribed policy counters available at the CHF for that subscriber. The PCF makes the policy decision. The (H-)PCF may create the UE policy container including UE policy information. In the case of roaming, the H-PCF may send the UE policy container in the Npcf_UEPolicyControl UpdateNotify Request. The H-PCF may provide updated policy control triggers for the UE policy association. The V-PCF sends a response to H-PCF using Npcf_UEPolicyControl UpdateNotify Response. The (V-)PCF provides the Policy Control Request Trigger parameters in the Npcf_UEPolicyControl UpdateNotify Request to the AMF. In the case of roaming, the V-PCF may also provide UE policy information to the UE. The V-PCF may also provide updated policy control triggers for the UE policy association to the AMF. The AMF sends a response to (V-)PCF.

In an example embodiment policy information may comprise access and mobility management (AM) policy information, session management (SM) policy information, and/or the like. In an example, the AMF access and mobility related policy information may be as follows shown in the table below:

Access and mobility related policy information

| | | | PCF permitted to | |
|---|---|---|---|---|
| Information | | | modify in a UE | |
| name | Description | Category | context in the AMF | Scope |
| Aggregated | This part defines the aggregated | | | |
| maximum bite | maximum bite rate | | | |
| rate | | | | |
| UE-AMBR | This defines the UE-AMBR | Conditional | Yes | UE context |
| | value that applies for a UE | | | |
| List of UE-Slice- | This defines the List of UE-Slice- | Conditional | Yes | UE context |
| MBR | MBR (UL/DL) that each applies | | | |
| | to the network slice of the UE. | | | |
| Service Area | This part defines the service | | | |
| Restrictions | area restrictions | | | |
| List of allowed | List of allowed TAIs | Conditional | Yes | UE context |
| TAIs. | | | | |
| List of non- | List of non-allowed TAIs | Conditional | Yes | UE context |
| allowed TAIs. | | | | |
| Maximum | The maximum number of | Conditional | Yes | UE context |
| number of | allowed TAIs. | | | |
| allowed TAIs | | | | |
| RFSP Index | This part defines the RFSP | | | |
| | index related information | | | |
| RFSP Index for | Defines the RFSP Index | Conditional | Yes | UE context |
| Allowed NSSAI | associated with Allowed NSSAI | | | |
| | that applies for a UE | | | |
| RFSP Index for | Defines the RFSP Index | Conditional | Yes | UE context |
| Target NSSAI | associated with Target NSSAI | | | |
| | that applies for a UE | | | |
| RFSP Index in | Defines the time by which the | Conditional | Yes | UE context |
| Use Validity | RFSP Index will be used in MME | | | |
| Time | after 5GS to EPS mobility. | | | |
| 5G access | This part defines the 5G access | | | |
| stratum time | stratum time distribution | | | |
| distribution | | | | |
| 5G access | Defines if 5G access stratum | Conditional | Yes | UE context |
| stratum time | time distribution via Uu | | | |
| distribution | reference point is enabled or | | | |
| indication | disabled | | | |
| Uu interface | Indicates the Uu Time | Conditional | Yes | UE context |
| time | Synchronization error budget for | | | |
| synchronization | 5G access stratum time | | | |
| error budget | distribution | | | |
| Clock quality | Defines which clock quality | Conditional | Yes | UE context |
| detail level | information (clock quality metrics | | | |
| | or acceptable/not acceptable | | | |
| | indication) to report to the UE as | | | |
| | defined in clause 5.27.1.12 of | | | |
| | TS 23.501 | | | |
| Clock quality | Indicates the acceptable criteria | Conditional | Yes | UE context |
| acceptance | as defined in clause 5.27.1.12 of | | | |
| criteria | TS 23.501 | | | |
| SMF selection | This part defines the SMF | | | |
| management | selection management | | | |
| | instructions | | | |
| DNN | Defines if a UE requested | Conditional | Yes | UE context |
| replacement of | unsupported DNN is requested | | | |
| unsupported | for replacement by PCF | | | |
| DNNs | | | | |
| List of S- | Defines the list of S-NSSAls | Conditional | Yes | UE context |
| NSSAIs | containing DNN candidates for | | | |
| | replacement by PCF | | | |
| Per S-NSSAI: | Defines UE requested DNN | Conditional | Yes | UE context |
| List of DNNs | candidates for replacement by | | | |
| | PCF | | | |
| Slice | Defines slice replacement | | Yes | UE context |
| replacement | management | | | |
| management | | | | |
| S-NSSAI | Defines the S-NSSAI availability | Conditional | Yes | UE context |
| availability | and/or alternative S-NSSAI for | | | |
| information | S-NSSAI | | | |
| Slice Related | Defines network policies for | | | |
| Restrictions | Slices subject to network control | | | |
| List of S- | Defines the List of S-NSSAIs | Conditional | No | UE context |
| NSSAIs | that are on demand | | | |
| Per S-NSSAI: | Defines the S-NSSAI | | No | UE context |
| Deregistration | deregistration inactivity timer | | | |
| Inactivity Timer | value before removing the S- | | | |
| value | NSSAI from the Allowed Slices | | | |
| Per S-NSSAI: | Defines the S-NSSAI allowed | | yes | UE context |
| Data volume | data volume | | | |
| restriction | | | | |
| indication/value | | | | |
| Per S-NSSAI: | Defines the S-NSSAI data | | yes | UE context |
| Data volume | volume restriction time period. | | | |
| restriction period | | | | |
| (time period) | | | | |
| Per S-NSSAI: | Defines the S-NSSAI allowed | | yes | UE context |
| Energy | energy consumption | | | |
| consumption | | | | |
| restriction | | | | |
| indication/value | | | | |
| Per S-NSSAI: | Defines the S-NSSAI energy | | yes | UE context |
| Energy | consumption restriction time | | | |
| consumption | period. | | | |
| restriction period | | | | |
| (time period) | | | | |

In example embodiments of the present disclosure when the AMF receives policy information, the policy information may be employed by the AMF. For example, when data volume per S-NSSAI restriction (e.g., Per S-NSSAI data volume restriction indication/value) or EC per S-NSSAI restriction (e.g., per S-NSSAI energy consumption restriction indication/value) is in place, the AMF may determine to perform a congestion control procedure or overload control procedure. For example, the AMF may send to the RAN an overload start message comprising the S-NSSAI for which the data volume threshold has been reached. The RAN node may determine to perform access barring for the S-NSSAI, or limit the signalling. For example, the AMF may send a NAS message indicating a congestion notification. In an example, the NAS message may comprise a timer value. In an example, the timer value may be based on the per S-NSSAI Data volume restriction period (time period), Per S-NSSAI energy consumption restriction period (time period), and/or the like.

In an example embodiment, the list of allowed TAIs may indicate the TAIs where the UE is allowed to be registered. The list of non-allowed TAIs may indicate the TAIs where the UE is not allowed to be registered. The Maximum number of allowed Tas may indicate the maximum number of allowed Tracking Areas, the list of TAI is defined in the AMF and not explicitly provided by the PCF. The RFSP Index for Allowed NSSAI and RFSP Index for Target NSSAI defines the RFSP Index for radio resource management functionality. RFSP Index in Use Validity Time defines the time for which the RFSP Index in use will be used in MME after 5GS to EPS mobility. The UE-AMBR limits the aggregated bit rate across all Non-GBR QoS Flows of a UE in the serving network. The list of UE-Slice-MBR defines the list of authorized UE-Slice-MBR allocated for a UE. The DNN replacement of unsupported DNNs indicates that the AMF shall contact the PCF for replacement of an unsupported DNN requested by the UE. The List of S-NSSAIs defines the S-NSSAIs, valid in the serving network, of the Allowed NSSAI that contain DNN candidates for replacement by PCF. The List of DNNs defines the DNN candidates for which the AMF shall contact the PCF for replacement if such a DNN is requested by a UE. The 5G access stratum time distribution indicates the 5G access stratum time distribution parameters to be indicated to the NG-RAN via AMF. The S-NSSAI availability information indicates whether the S-NSSAI is not available or is available, and/or an alternative S-NSSAI that the S-NSSAI can be replaced with.

In an example, the purpose of the PDU Session related policy information may be to provide policy and charging control related information that is applicable to a single Monitoring key or the whole PDU Session respectively. The PCF may provide PDU Session related policy information to the SMF together with PCC rules or separately.

The following table depicts the PDU session related policy information.

PDU Session related policy information

| | | PCF permitted to | |
|---|---|---|---|
| | | modify for | |
| | | dynamically | |
| | | provided | |
| Attribute | Description | information | Scope |
| Charging information | Defines the containing CHF address | No | PDU Session |
| | and optionally the associated CHF | | |
| | instance ID and CHF set ID. | | |
| Default charging method | Defines the default charging method | No | PDU Session |
| | for the PDU Session. | | |
| PDU Session with offline | Indicates that the “online” charging | No | PDU Session |
| charging only | method is never used for PCC rules | | |
| | in the PDU Session. | | |
| Policy control request | Defines the event(s) that shall cause | Yes | PDU Session |
| trigger | a re-request of PCC rules for the | | |
| | PDU Session. | | |
| Authorized QoS per bearer | Defines the authorised QoS for the | Yes | IP-CAN bearer |
| (UE-initiated IP-CAN | IP-CAN bearer (QCI, GBR, MBR). | | |
| bearer | | | |
| activation/modification) | | | |
| Authorized MBR per QCI | Defines the authorised MBR per QCI. | Yes | IP-CAN |
| (network initiated IP-CAN | | | session |
| bearer | | | |
| activation/modification) | | | |
| Revalidation time limit | Defines the time period within which | Yes | PDU Session |
| | the SMF shall perform a PCC rules | | |
| | request. | | |
| PRA Identifier(s) | Defines the Presence Reporting | Yes | PDU Session |
| | Area(s) to monitor for the UE with | | |
| | respect to entering/leaving | | |
| List(s) of Presence | Defines the elements of the | Yes | PDU Session |
| Reporting Area elements | Presence Reporting Area(s) | | |
| Default NBIFOM access | The access to be used for all traffic | Yes (only at the | IP-CAN |
| | that does not match any existing | addition of an | session |
| | Routing Rule | access to the IP- | |
| | | CAN session) | |
| IP Index | Provided to SMF to assist in | No | PDU Session |
| | determining the IP Address allocation | | |
| | method (e.g. which IP pool to assign | | |
| | from) when a PDU Session requires | | |
| | an IP address - | | |
| Redundant PDU Session | Indicates whether the PDU Session | No | PDU Session |
| | is a redundant PDU Session | | |
| Explicitly signalled QoS | Defines a dynamically assigned 5QI | No | PDU Session |
| Characteristics | value (from the non-standardized | | |
| | value range) and the associated 5G | | |
| | QoS characteristics. | | |
| Reflective QoS Timer | Defines the lifetime of a UE derived | No | PDU Session |
| | QoS rule belonging to the PDU | | |
| | Session. | | |
| Authorized Session-AMBR | Defines the Aggregate Maximum Bit | Yes | PDU Session |
| | Rate for the Non-GBR QoS Flows of | | |
| | the PDU Session. | | |
| Authorized default | Defines the default 5QI and ARP of | Yes | PDU Session |
| 5QI/ARP | the QoS Flow associated with the | | |
| | default QoS rule. | | |
| Time Condition | Defines the time at which the | No | PDU Session |
| | corresponding Subsequent | | |
| | Authorized Session-AMBR or | | |
| | Subsequent Authorized default | | |
| | 5QI/ARP shall be applied. | | |
| Subsequent Authorized | Defines the Aggregate Maximum Bit | No | PDU Session |
| Session-AMBR | Rate for the Non-GBR QoS Flows of | | |
| | the PDU Session when the Time | | |
| | Condition is reached. | | |
| Subsequent Authorized | Defines the default 5QI and ARP | No | PDU Session |
| default 5QI/ARP | when the Time Condition is reached. | | |
| Usage Monitoring | Defines the information that is | | |
| Control related | required to enable user plane | | |
| information | monitoring of resources for individual | | |
| | applications/services, groups of | | |
| | applications/services, for a PDU | | |
| | Session. | | |
| Monitoring key | The PCF uses the monitoring key to | No | PDU Session |
| | group services that share a common | | |
| | allowed usage. | | |
| Power/Energy | Defines the value of energy | Yes | Monitoring key |
| consumption threshold | consumed after which the SMF may | | |
| | report usage to the PCF for this | | |
| | monitoring key. | | |
| EC Time threshold | Defines the resource time usage | Yes | Monitoring key |
| | after which the SMF may report EC | | |
| | consumption report to the PCF. | | |
| EC Monitoring time | Defines the time at which the SMF | No | Monitoring Key |
| | may reapply the Power/Energy | | |
| | consumption threshold | | |
| | and/or EC Time Threshold. | | |
| Per S-NSSAI: | Defines the S-NSSAI allowed data | Yes | Monitoring key |
| Data volume restriction | volume | | |
| indication/value | | | |
| Per S-NSSAI: | Defines the S-NSSAI data volume | Yes | Monitoring key |
| Data volume restriction | restriction time period. | | |
| period (time period) | | | |
| Per S-NSSAI: | Defines the S-NSSAI allowed energy | Yes | Monitoring Key |
| Energy consumption | consumption | | |
| restriction indication/value | | | |
| Per S-NSSAI: | Defines the S-NSSAI energy | Yes | Monitoring Key |
| Energy consumption | consumption restriction time period. | | |
| restriction period (time | | | |
| period) | | | |
| Volume threshold | Defines the traffic volume value after | Yes | Monitoring key |
| | which the SMF may report usage to | | |
| | the PCF for this monitoring key. | | |
| Time threshold | Defines the resource time usage | Yes | Monitoring key |
| | after which the SMF may report | | |
| | usage to the PCF. | | |
| Monitoring time | Defines the time at which the SMF | No | Monitoring Key |
| | shall reapply the Volume and/or Time | | |
| | Threshold. | | |
| Subsequent Volume | Defines the traffic volume value after | No | Monitoring Key |
| threshold | which the SMF may report usage to | | |
| | the PCF for this Monitoring key for | | |
| | the period after the Monitoring time. | | |
| Subsequent Time | Defines resource time usage after | No | Monitoring Key |
| threshold | which the SMF shall report usage to | | |
| | the PCF for this Monitoring key for | | |
| | the period after the Monitoring time. | | |
| Inactivity Detection Time | Defines the period of time after which | Yes | Monitoring Key |
| | the time measurement shall stop, if | | |
| | no packets are received. | | |
| Ethernet or IP port | | | |
| management related | | | |
| Port number | Port number for which Port | Yes | PDU Session |
| | Management Information Container | | |
| | is provided. | | |
| Port Management | Includes Ethernet/IP port | Yes | PDU Session |
| Information Container | management information. | | |
| User plane node | Includes User plane node | Yes | |
| Management Information | management information. | | |
| Container | | | |
| Target of reporting | Target of reporting (indicated as | Yes | PDU Session |
| | Notification Target Address + | | |
| | Notification Correlation ID). | | |
| PDU Slice Inactivity Timer | Defines the Slice inactivity timer | | |
| value | value before releasing the PDU | | |
| | session. | | |
| VPLMN Specific | HR-SBO policy for the local part of | | |
| Offloading Policy | DN in VPLMN. | | |
| IP range(s) | IP address range(s) allowed to be | Yes | PDU Session |
| | routed to the local part of DN in | | |
| | VPLMN. | | |
| FQDN(s) | FQDN(s) allowed to be routed to the | Yes | PDU Session |
| | local part of DN in VPLMN. | | |
| Authorized DL Session | Defines the DL Aggregate Maximum | Yes | PDU Session |
| AMBR for Offloading | Bit Rate for the Non-GBR QoS Flows | | |
| | of the PDU Session authorized for | | |
| | offloading to the local part of DN in | | |
| | VPLMN. | | |

In example embodiments of the present disclosure when the SMF receives policy information, the policy information may be employed by the SMF. For example, when data volume per S-NSSAI restriction (e.g., Per S-NSSAI data volume restriction indication/value) or EC per S-NSSAI restriction (e.g., per S-NSSAI energy consumption restriction indication/value) is in place, the SMF may determine to perform a congestion control procedure or overload control procedure. For example, the SMF may receive an N4 report message from the UPF indicating that energy consumption associated with the PDU session, or S-NSSAI, or QoS flow has been reached. For example, the SMF may send a NAS message (SM NAS) indicating a congestion notification. In an example, the NAS message may comprise a timer value. In an example, the timer value may be based on the EC time threshold, EC monitoring time, the per S-NSSAI Data volume restriction period (time period), Per S-NSSAI energy consumption restriction period (time period), and/or the like. In an example, the SMF may perform a network triggered PDU session modification to modify the S-NSSAI, the QoS, and/or the like. The SMF may send a NAS message to the UE. The SMF may determine/decide to modify PDU Session. This procedure also may be triggered to update QoS profile in the NG RAN and PDU Set information marking in the PSA UPF. The SMF may need to report some subscribed event to the PCF by performing an SMF initiated SM Policy Association Modification procedure. If dynamic PCC is not deployed, the SMF may apply local policy to decide whether to change the QoS profile. The SMF may update the UPF with N4 Rules related to new or modified QoS Flow(s). This allows the UL packets with the QFI of a new or modified QoS Flow to be transferred. If the SMF initiated the PDU Session Modification procedure due to PCF initiated SM Policy Association Modification that adds one or more PCC Rule(s) with a TSC Assistance Container and if interworking with TSN deployed in the transport network is supported and the UPF does not support CN-TL, the SMF instructs the UPF to assign a distinct N3 tunnel end point address for the QoS Flow(s) assigned with a TSC Assistance Container. For SMF requested modification, the SMF may invoke to the AMF, Namf_Communication_N1N2Message Transfer ([N2 SM information] (PDU Session ID, QFI(s), QoS Profile(s), [Alternative QoS Profile(s)], Session-AMBR, [CN Tunnel Info(s)], QOS Monitoring indication, QoS Monitoring reporting frequency), [TSCAI(s)], TL-Container, [ECN marking for L4S indicator(s)]), N1 SM container (PDU Session Modification Command (PDU Session ID, QoS rule(s), QoS Flow level QoS parameters if needed for the QoS Flow(s) associated with the QoS rule(s), QoS rule operation and QoS Flow level QoS parameters operation, Session-AMBR))). The AMF may send N2 ([N2 SM information received from SMF], NAS message (PDU Session ID, N1 SM container (PDU Session Modification Command))) Message to the (R)AN. The (R)AN may issue AN specific signalling exchange with the UE that is related with the information received from SMF. For example, in the case of a NG-RAN, an RRC Connection Reconfiguration may take place with the UE modifying the necessary (R)AN resources related to the PDU Session or if only N1 SM container is received in step 4 from AMF, RAN transports only the N1 SM container to the UE.

In an example embodiment, upon the initial interaction with the SMF, the PCF may provide the following attributes to the SMF: The Charging information contains addresses of the CHF that manages charging for the PDU Session and optionally the associated CHF instance ID and CHF set ID. The Default charging method indicates what charging method may be used in the PDU Session for every PCC rule where the charging method identifier may be omitted, including predefined PCC rules that are activated by the SMF. If received by the SMF, it may supersede the Default charging method in the charging characteristics profile. The PDU Session with offline charging only may be assigned to a PDU Session by the PCF to indicate that the online charging method is never set for any of the PCC Rules activated during the lifetime of the PDU Session nor provided as Default charging method. The IP Index may indicate the IP Address/Prefix allocation method which is used by the SMF for IP Address/Prefix allocation during PDU Session Establishment procedure.

In an example embodiment, upon every interaction with the SMF, the PCF may provide the following attributes to the SMF:

The Revalidation time limit defines the time period within which the SMF shall trigger a request for PCC rules for an established PDU Session. The Reflective QoS Timer defines the lifetime of a UE derived QoS rule belonging to the PDU Session. The Authorized Session-AMBR defines the UL/DL Aggregate Maximum Bit Rate for the Non-GBR QoS Flows of the PDU Session, which is enforced in the UPF. The PCF may provide the Authorized Session-AMBR in every interaction with the SMF. When the SMF receives it from the PDU Session policy, it is provided to the UPF over N4 interface for the enforcement. The Authorized default 5QI/ARP defines the 5QI and ARP values of the QoS Flow associated with the default QoS rule. The PCF may provide a 5QI Priority Level together with the Authorized default 5QI, when a 5QI Priority Level value different from the standardized Default Priority Level value in the QoS characteristics is required. The SMF applies the Authorized default 5QI/ARP also for the QoS Flow binding. The Time Condition and Subsequent Authorized Session-AMBR/Subsequent Authorized default 5QI/ARP are used together and up to four instances with different values of the Time Condition parameter may be provided by the PCF. Time Condition indicates that the associated Subsequent Authorized Session-AMBR/Subsequent Authorized default 5QI/ARP is only applied when the time defined by this attribute is met. The PCF may provide a 5QI Priority Level together with the Subsequent Authorized default 5QI, when a 5QI Priority Level value different from the standardized Default Priority Level value in the QoS characteristics is required. When the SMF receives a Time Condition and Subsequent Authorized Session-AMBR/Subsequent Authorized default 5QI/ARP pair, it stores it locally. The SMF may discard any previously received Subsequent Authorized Session-AMBR/Subsequent Authorized default 5QI/ARP instances on explicit instruction as well as whenever the PCF provides a new instruction for one or more Subsequent Authorized Session-AMBR/Subsequent Authorized default 5QI/ARP. When the time defined by the Time Condition parameter is reached, the SMF may apply (or instruct the UPF to apply) Subsequent Authorized Session-AMBR/Subsequent Authorized default 5QI/ARP.

In an example, the Monitoring Key is the reference to a resource threshold. Any number of PCC Rules may share the same monitoring key value. The monitoring key values for each service may be operator configurable. It may be possible for an operator to use the Monitoring Key parameter to indicate usage monitoring on an PDU Session level, NF level S-NSSAI level, slice instance level, QoS flow level or, in the case of an MA PDU Session, to indicate usage monitoring on PDU Session level, NF level, S-NSSAI level, slice instance level, QoS flow level for the 3GPP access and/or the Non-3GPP access.

Usage monitoring on PDU Session level is active when a PDU Session is active when a Monitoring Key for the PDU Session and a corresponding volume and/or time threshold value have been provided to the SMF. Usage monitoring on Monitoring key level is active when a volume and/or time threshold has been provided for a Monitoring Key to the SMF and there is at least one PCC rule active for the PDU Session that is associated with that Monitoring Key.

In an example embodiment, the Power/Energy consumption threshold may indicate a value that when exceeded a threshold, the SMF may send a report indicating that the power/energy consumption threshold has been reached. In an example, the report may indicate that the power/energy consumption threshold for a NF has been reached. In an example, the report may indicate that the power/energy consumption threshold for a PDU session has been reached. In an example, the report may indicate that the power/energy consumption threshold for a S-NSSAI has been reached. In an example, the report may indicate that the power/energy consumption threshold for a UE has been reached. In an example, the report may indicate that the power/energy consumption threshold for an access leg, access type, RAT type of an MA PDU session has been reached.

In an example access legs of the MA PDU session may employ the same S-NSSAI. In an example, a first access leg of the MA PDU session may employ a first S-NSSAI and a second access leg of the MA PDU session may employ a second S-NSSAI. In an example, the report may indicate that the power/energy consumption threshold for the first S-NSSAI has been reached. In an example, the report may indicate that the power/energy consumption threshold for the second S-NSSAI has been reached.

The EC Time threshold indicates the overall resource time usage after which the SMF shall report the Power/Energy consumption threshold reached trigger to the PCF.

The EC Monitoring time indicates the time at which the SMF may store the accumulated energy consumption information.

The Volume threshold indicates the overall user traffic volume value after which the SMF shall report the Usage threshold reached trigger to the PCF.

The Time threshold indicates the overall resource time usage after which the SMF shall report the Usage threshold reached trigger to the PCF.

The Monitoring time indicates the time at which the SMF shall store the accumulated usage information.

The Subsequent Volume threshold indicates the overall user traffic volume value measured after Monitoring time, after which the SMF may report the Usage threshold reached trigger to the PCF. The Subsequent Time threshold indicates the overall resource time usage measured after Monitoring time, after which the SMF may report the Usage threshold reached trigger to the PCF. The Inactivity Detection Time indicates the period of time after which the time measurement may stop, if no packets are received during that time period. The Port Management Information Container carries Ethernet or IP port management information for an Ethernet/IP port located in DS-TT or NW-TT. The port for which the container is provided is identified by the port number. The User plane node Management Information Container carries User plane node management information for a 5GS Bridge or Router. The VPLMN specific roaming offloading policy carries the attributes for the traffic to be offloaded to the local part of DN in VPLMN. The following attributes under this policy is applicable for the serving VPLMN. When the H-SMF receives it from PCF and HR-SBO is authorized, H-SMF shall send this policy to the V-SMF. The V-SMF may use this information to configure V-EASDF, ULCL/BP UPF and Local UPF. The IP range(s) indicates one or more IPV4/IPV6 address range(s) that are allowed to be offloaded to the local part of the DN in VPLMN when the PDU Session is authorized for HR-SBO. The FQDN(s) indicates one or more FQDN or FQDN range expressed by regular expression that are allowed to be offloaded to the local part of the DN in VPLMN when the PDU Session is authorized for HR-SBO. The Authorized Session-AMBR for Offloading defines the DL Aggregate Maximum Bit Rate for the Non-GBR QoS Flows applicable for the local traffic offloaded to the local part of DN in VPLMN of the PDU Session for HR-SBO.

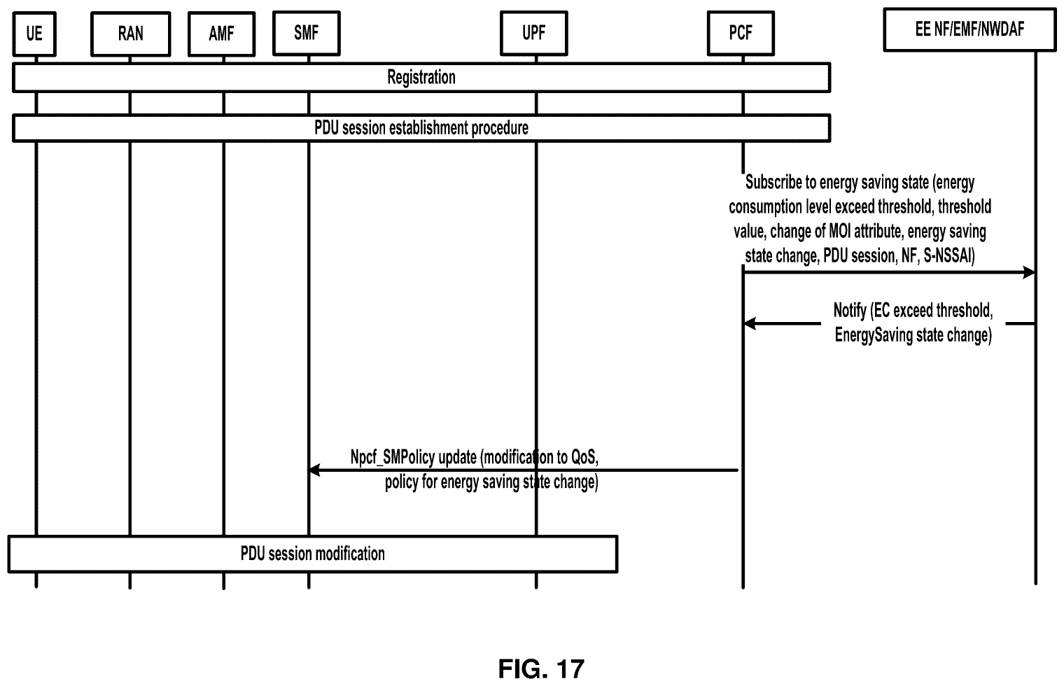

In an example as depicted in FIG. 17, the PCF may receive a notification from a network entity that is for energy consumption and management of energy saving states. The network entity may be the analytics function, the NWDAF, the EMF, the EBF, the EE NF, and/or the like. In an example, the PCF may receive the notification in response to sending the subscription request message to the network entity (e.g., analytics function, the NWDAF, the EMF, the EBF, the EE NF, and/or the like). In an example, the subscription request message may be an Nnwdaf message, Nemf message, Nebf message, Neenf message, and/or the like. In an example, the subscription request message may comprise conditions for reporting an event to the PCF. In an example, the event may comprise the event that corresponds to energy consumption related events such as energy consumption exceeding a threshold. In an example, the energy consumption may be associated with the UE, the PDU session of the UE, a QoS flow of the UE, a QoS flow of the PDU session, a S-NSSAI, and/or the like. In an example, the event may be associated with a NF, or NE of the 3GPP network or the PLMN, SNPN, NPN, and/or the like.

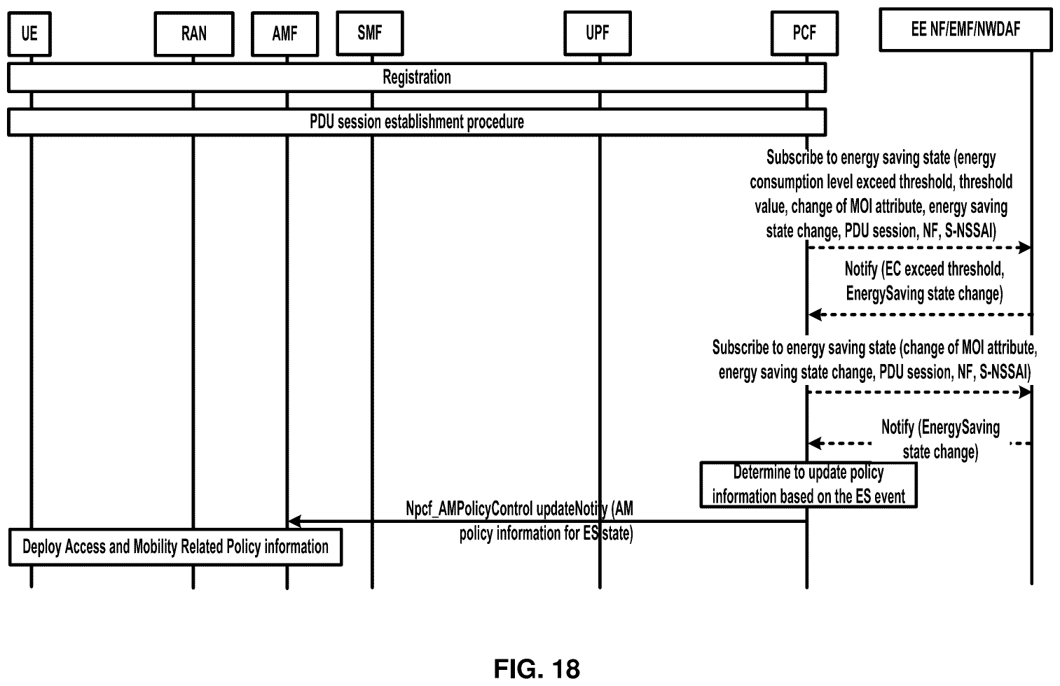

In an example, as depicted in FIG. 18, the PCF may trigger update of AM policy. In an example, the PCF may receive a notification from a network entity that is for energy consumption and management of energy saving states. The network entity may be an analytics function, an NWDAF, an EMF, an EBF, an EE NF, and/or the like. In an example, the PCF may receive the notification in response to sending a subscription request message to the network entity (e.g., analytics function, the NWDAF, the EMF, the EBF, the EE NF, and/or the like). In an example, the subscription request message may be an Nnwdaf message, Nemf message, Nebf message, Neenf message, and/or the like. In an example, the subscription request message may comprise conditions for reporting an event to the PCF. In an example, the event may comprise the event that corresponds to energy consumption related events such as energy consumption exceeding a threshold. In an example, the energy consumption may be associated with the UE, the PDU session of the UE, a QoS flow of the UE, a QoS flow of the PDU session, a S-NSSAI, and/or the like. In an example, the event may be associated with a NF, or NE of the 3GPP network or the PLMN, SNPN, NPN, and/or the like. In an example embodiment, the event may correspond to an energy saving status change such as a change in managed object instance (MOI) attribute (value) of a NE or a NF. In an example, the NF may correspond to the UE, the PDU session of the UE, a QoS flow of the UE, a QoS flow of the PDU session, a S-NSSAI, and/or the like. In an example embodiment, the MOI attribute may be associated with the PDU session of the UE, a QoS flow of the UE, a QoS flow of the PDU session, a S-NSSAI, and/or the like.

The PCF may send to the AMF the Npcf_AMPolicyControl_UpdateNotify message that may comprise the policy information as described in example embodiments e.g., AM policy information. The AMF may deploy the access and mobility related policy information which includes storing the Service Area Restrictions and Policy Control Request Trigger(s) of the AM Policy Association, provisioning Service Area Restrictions to the UE and provisioning the RFSP index, the UE-AMBR, List of UE-Slice-MBR, Service Area Restrictions to the NG-RAN and request for notification of SM Policy association establishment and termination to a list of (DNN, S-NSSAI) (s) together with PCF for the UE binding information. In an example the access and mobility related policy may comprise the following:

| | | | |
|---|---|---|---|
| Per S-NSSAI: | Defines the S-NSSAI | No | UE context |
| Deregistration | deregistration inactivity timer | | |
| Inactivity Timer | value before removing the S- | | |
| value | NSSAI from the Allowed Slices | | |
| Per S-NSSAI: | Defines the S-NSSAI allowed | yes | UE context |
| Data volume | data volume | | |
| restriction | | | |
| indication/value | | | |
| Per S-NSSAI: | Defines the S-NSSAI data | yes | UE context |
| Data volume | volume restriction time period. | | |
| restriction period | | | |
| (time period) | | | |
| Per S-NSSAI: | Defines the S-NSSAI allowed | yes | UE context |
| Energy | energy consumption | | |
| consumption | | | |
| restriction | | | |
| indication/value | | | |
| Per S-NSSAI: | Defines the S-NSSAI energy | yes | UE context |
| Energy | consumption restriction time | | |
| consumption | period. | | |
| restriction period | | | |
| (time period) | | | |

In an example embodiment, the PCF may trigger a UE configuration update (UCU) procedure and send a URSP to the UE. In an example, the network (e.g., the SMF, the AMF and/or the like may send a NAS message to the UE. In an example, the NAS message may be the UCU command message. In an example, the NAS message may comprise a parameter, a configuration parameter, the URSP, and/or the like. In an example, the NAS message may comprise one or more S-NSSAIs that are subject to network controlled energy saving restrictions. In an example, the UCU command message may comprise a time duration of the restriction. In an example, the NAS message may comprise one or more of the per S-NSSAI data volume restriction indication/value, per S-NSSAI Data volume restriction period (time period), per S-NSSAI energy consumption restriction indication/value, Per S-NSSAI energy consumption restriction period (time period).

In an example embodiment, the UE may receive the NAS message from the AMF or the SMF. The UE may employ an element of the NAS message to perform a PDU session modification. The PDU session modification that may cause modification of the QoS flow of a PDU session, modification of S-NSSAI of the PDU session. In an example, based on an element of the NAS message the UE may determine to limit the volume of data transmitted via a PDU session using one or more S-NSSAI(s).

The (V-)PCF may store the information received and may make the policy decision. In the non-roaming case, the PCF may subscribe to Analytics from NWDAF. In an example, the PCF may subscribe to energy consumption related events to EMF, EE NF, EBF, and/or the like. If the PCF determines a change to policy counter status reporting is required, it may alter the subscribed list of policy counters using the Initial, Intermediate or Final Spending Limit Report Retrieval procedures.

The (V-)PCF may respond to the AMF with the updated access and mobility related policy information and the updated Policy Control Request Trigger parameters. If an AF has previously subscribed to request for allocation of service area coverage outcome event, the (V-)PCF checks if reporting is needed, using the Policy Control Request Trigger that was met as input, then sends a respective notification to the AF using Npcf_AMPolicyAuthorization_Notify.

The AMF may deploy the access and mobility related policy information, which includes storing the Service Area Restrictions and Policy Control Request Trigger of AM Policy Association, provisioning the Service Area Restrictions to the UE and provisioning the RFSP index, UE-AMBR, List of UE-Slice-MBR, Service Area Restrictions to the NG-RAN and request for notification of SM Policy association establishment and termination to a list of (DNN, S-NSSAI) (s) together with PCF for the UE binding information.

In example embodiments of the present disclosure when the AMF receives policy information, the policy information may be employed by the AMF. For example, when data volume per S-NSSAI restriction (e.g., Per S-NSSAI data volume restriction indication/value) or EC per S-NSSAI restriction (e.g., per S-NSSAI energy consumption restriction indication/value) is in place, the AMF may determine to perform a congestion control procedure or overload control procedure. For example, the AMF may send to the RAN an overload start message comprising the S-NSSAI for which the data volume threshold has been reached. The RAN node may determine to perform access barring for the S-NSSAI, or limit the signalling. For example, the AMF may send a NAS message indicating a congestion notification. In an example, the NAS message may comprise a timer value. In an example, the timer value may be based on the per S-NSSAI Data volume restriction period (time period), Per S-NSSAI energy consumption restriction period (time period), and/or the like.

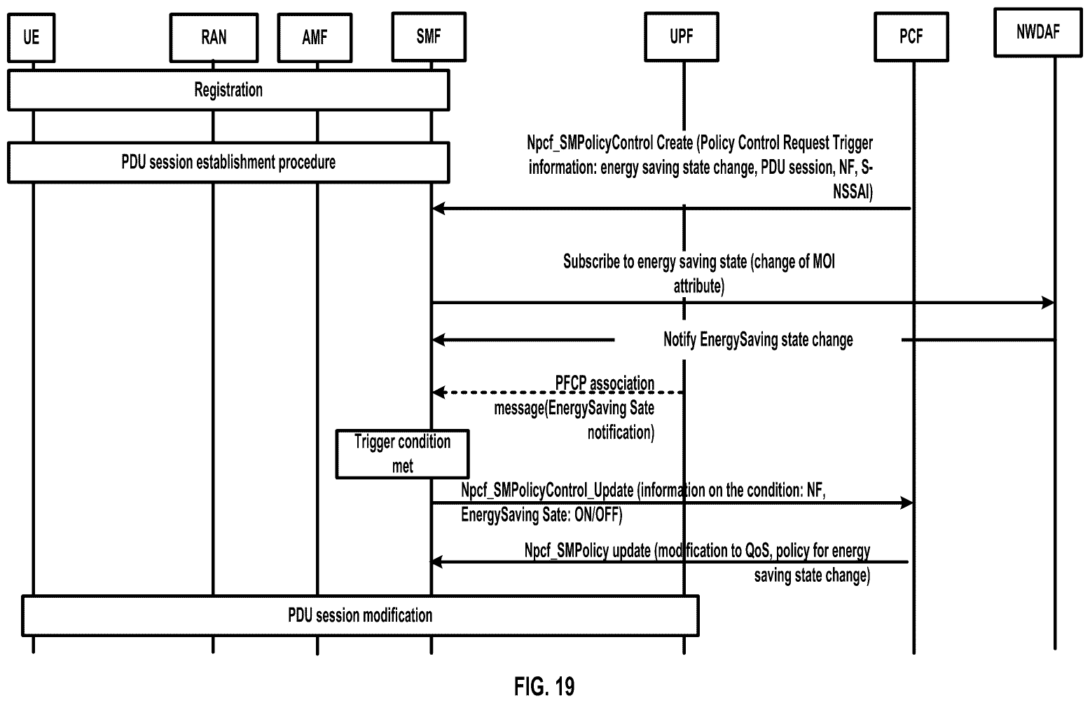

In an example embodiment as depicted in FIG. 19, a UE may register with the network by sending a NAS message to the AMF. In an example, the NAS message may comprise a capability indication of network controlled energy saving optimization support. In an example, the capability indication indicates that the UE supports network controlled energy saving optimization feature. In an example, the feature may enable the UE to limit data volume of a PDU session, QoS flow, S-NSSAI, DNN, and/or the like when the UE receives an indication that network energy consumption control is activated for resources supporting the connections of the UE. In an example, the AM policy association establishment procedure may be performed. In an example, when the AMF receives the indication, the AMF may provide the indication to the PCF e.g., during the AP policy association procedure.

In an example embodiment, the UE may register with the network by sending a NAS message to the AMF. In an example, the NAS message may comprise a registration request. In an example, the UE may receive from the network e.g., the AMF or the SMF a capability indication of network controlled energy saving optimization support. In an example, the capability indication indicates that the network supports network controlled energy saving optimization feature. In an example, the feature may enable the network implement a policy for energy saving status, to limit data volume of a PDU session, QoS flow, S-NSSAI, DNN, and/or the like when the AMF or the SMF receive an updated policy information in response to the triggering condition (as described in example embodiments) being met.

In an example, based on the indication, the PCF may configure the AMF for PCRT. The configuration for PCRT may comprise sending by the PCF to the AMF a message comprising the PCRT. The PCRT may comprise the AMF related PCRT.

In an example, when a Policy Control Request Trigger condition is met, the AMF updates the AM Policy Association and provides information on the conditions that have changed to the PCF by invoking Npcf_AMPolicyControl_Update.

In an example, the AMF may subscribe to the energy consumption related events via the NWDAF, EMF, the EE NF, the EBF, and/or the like. When a notification is received by the AMF from one or more of the NWDAF, EMF, EE NF, EBF, and/or the like, the AMF determines that the trigger condition is met. The AMF may send to the PCF a request to update policy.

In an example, Policy Control Request (PCR) Triggers relevant for SMF may define the conditions when the SMF may interact again with PCF after a PDU Session establishment as defined in the Session Management Policy Establishment and Session Management Policy Modification procedures described in example embodiments. The PCR triggers may not be applicable any longer at termination of the SM Policy Association. The access independent Policy Control Request Triggers relevant for SMF are listed in table below.

Access independent Policy Control
Request Triggers relevant for SMF

| Policy Control Request Trigger | Description |
|---|---|
| Energy consumption of PDU | EC level pertaining to resources |
| session exceed a threshold, | associated with a PDU session |
| threshold value | exceed threshold. |
| energy saving status (mode) | State of energy saving of the NF |
| of NF serving a PDU session | changed to ON or OFF. State of |
| | energy saving mode changed from/ |
| | to partial to/from full. |
| Energy consumption of a NF | EC level pertaining to resources |
| exceed threshold, threshold | associated with a NE/NF exceed |
| value | threshold. |
| Energy consumption of a QoS | EC level pertaining to resources |
| flow, S-NSSAI, UE, Application | associated with a QoS flow, S-NSSAI, |
| ID exceed threshold, threshold | UE, Application ID exceed threshold. |
| value | |

during a PDU session establishment procedure, PDU session modification procedure, service request procedure, registration procedure, and/or the like, the SMF may perform an SM Policy Association Establishment procedure to establish an SM Policy Association with the PCF and get the default PCC Rules for the PDU Session. The GPSI, PVS FQDN(s) and/or PVS IP address(es) and the Onboarding Indication may be included if available at SMF in the case of ON-SNPN. If the Request Type indicates “Existing PDU Session”, the SMF may provide information on the Policy Control Request Trigger condition(s) that have been met by an SMF initiated SM Policy Association Modification procedure. The PCF may provide policy information to SMF. The URSP rule enforcement may be included if SMF receives the URSP rule enforcement from UE. The PCF for the UE subscribes to notifications of event “UE reporting Connection Capabilities from associated URSP rule”, using Npcf_PolicyAuthorization_Subscribe (EventId set to “UE reporting Connection Capabilities from associated URSP rule”, EventFilter set to at least “list of Connection Capabilities”) to the PCF for the PDU Session. The PCF for session may notify the PCF for UE about the URSP rule enforcement together with the PDU session parameters that this application associated with by Npcf_PolicyAuthorization_Notify.

During the SM Policy Association Establishment procedure, if the PCF detects the request relates to SM Policy Association for a PDU session of a UE that supports network controlled energy saving, the PCF may provide policy control request trigger to network functions such as SMF, AMF, EMF, EE NF, NWDAF, and/or the like.

During the SM Policy Association Establishment procedure, if the PCF detects the request relates to SM Policy Association enabling integration with TSN or TSC or Deterministic Networking based on local configuration, the PCF may provide policy control request trigger for 5GS Bridge/Router Information.

In an example, the PCC rules may be employed for UPF selection. For example, the UPF may be selected if energy consumption of the UPF is below a threshold. For example, the PCC rule may indicate selection of a NF such as UPF, if renewable energy is used. For example, a preference of the UE or the PCC rule may prioritize resources that consume renewable energy, green energy, and/or the like.

During the SM Policy Association Establishment procedure for a non-roaming PDU Session, if a S-NSSAI is subject to network slice usage control, the PCF may provide a Slice Usage Policy information including whether a network slice is on demand and a PDU Session inactivity timer value. In an example, during the SM Policy Association Establishment procedure for a PDU session, if a S-NSSAI is subject to network slice energy consumption control, the PCF may provide a slice policy information including whether a network slice usage is restricted due to energy consumption control by the network. In an example, the PCF may provide a PDU session timer value. In an example, the PDU session timer value may indicate a time duration for which the PDU session may not use the S-NSSAI.

In an example embodiment, the SMF may determine that the trigger condition as described in example embodiment has been met. In response to the determining, the SMF may send to the PCF a message to update (Npcf_SMPolicyControl_Update) the SM Policy Association and provides information on the conditions that have been met. In an example, the information of the condition may correspond to energy consumption related events such as energy consumption exceeding a threshold e.g., an event is triggered. In an example, the energy consumption may be associated with the UE, the PDU session of the UE, a QoS flow of the UE, a QoS flow of the PDU session, a S-NSSAI, and/or the like. In an example, the information of the condition may correspond to an energy saving status change such as a change in managed object instance (MOI) attribute (value) of a NF. In an example, the NF may correspond to the UE, the PDU session of the UE, a QoS flow of the UE, a QoS flow of the PDU session, a S-NSSAI, and/or the like. In an example embodiment, the MOI attribute (value) may be associated with the PDU session of the UE, a QoS flow of the UE, a QoS flow of the PDU session, a S-NSSAI, and/or the like. For example, the NF may be the UPF, SMF, AMF, and/or the like.

In an example, the PCF may provide policy information to the SMF. In an example, the policy information (as described in example embodiments) may comprise the access and mobility management (AM) policy information, the session management (SM) policy information, and/or the like. In an example, the PCF may provide the policy information to the AMF. In an example, in response to receiving the policy information, the SMF may perform a PDU session modification to update the QoS information or S-NSSAI, DNN, and/or the like of the PDU session.

In an example embodiment, the SMF may determine that the trigger condition as described in example embodiment has been met. The determining may be based on receiving a notification from the NF such as the UPF indicating a change in energy consumption or energy saving state/status of the NF. For an example of the UPF, the UPF may notify the SMF via node level signaling messages such as N4 association or PFCP association messages. In an example, the UPF may notify the SMF via session level signaling messages such as N4 session or PFCP session messages and may employ N4/PFCP reporting procedures. For example, the PFCP message may comprise indication of the event that correspond to energy consumption related events such as energy consumption of the UPF exceeding a threshold. In an example, the energy consumption may be associated with the UPF that serves the network (PLMN, SNPN, NPN), the UE, the PDU session of the UE, a QoS flow of the UE, a QoS flow of the PDU session, a S-NSSAI, and/or the like. In an example, the information of the condition may correspond to an energy saving status change such as a change in managed object instance (MOI) attribute (value) of the UPF. In an example, the NF may correspond to the network, the UE, the PDU session of the UE, a QoS flow of the UE, a QoS flow of the PDU session, a S-NSSAI, and/or the like. In an example embodiment, the MOI attribute (value) may be associated with (the UPF that serves) the PDU session of the UE, a QoS flow of the UE, a QoS flow of the PDU session, a S-NSSAI, and/or the like.

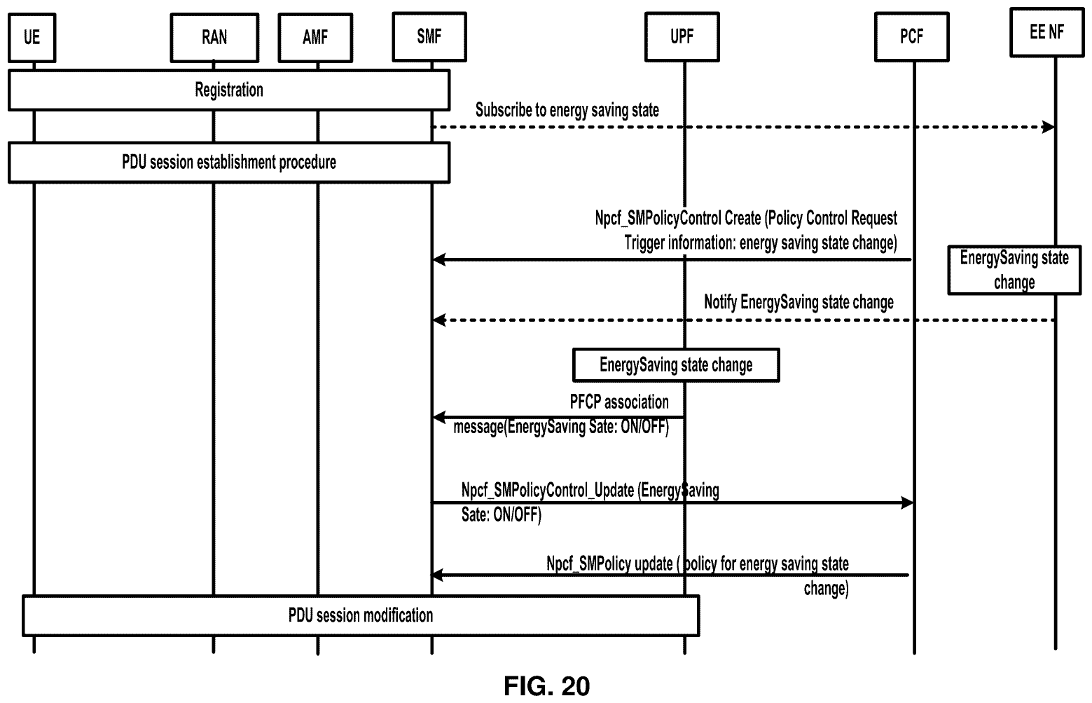

In an example embodiment, as depicted in FIG. 19 and FIG. 20, the SMF may determine that the trigger condition as described in an example embodiment has been met. The determining may be based on receiving a notification from the NWDAF or EE NF, the EMF, the EBF, and/or the like, indicating a change in energy consumption or energy saving state/status of the NF. For an example of the NF may be the UPF, SMF, AMF, and/or the like. the UPF may notify the SMF via node level signaling messages such as N4 association or PFCP association messages. In an example, the notification may comprise indication of the event that correspond to energy consumption related events such as energy consumption of the NF/NE exceeding a threshold. In an example, the energy consumption may be associated with the NF/NE that serves the network (PLMN, SNPN, NPN), the UE, the PDU session of the UE, a QoS flow of the UE, a QoS flow of the PDU session, a S-NSSAI, and/or the like. In an example, the information of the condition may correspond to an energy saving status change such as a change in managed object instance (MOI) attribute (value) of the NF/NE. In an example, the NF may correspond to the network, the UE, the PDU session of the UE, a QoS flow of the UE, a QoS flow of the PDU session, a S-NSSAI, and/or the like. In an example embodiment, the MOI attribute (value) may be associated with (the NF/NE that serves) the PDU session of the UE, a QoS flow of the UE, a QoS flow of the PDU session, a S-NSSAI, and/or the like.

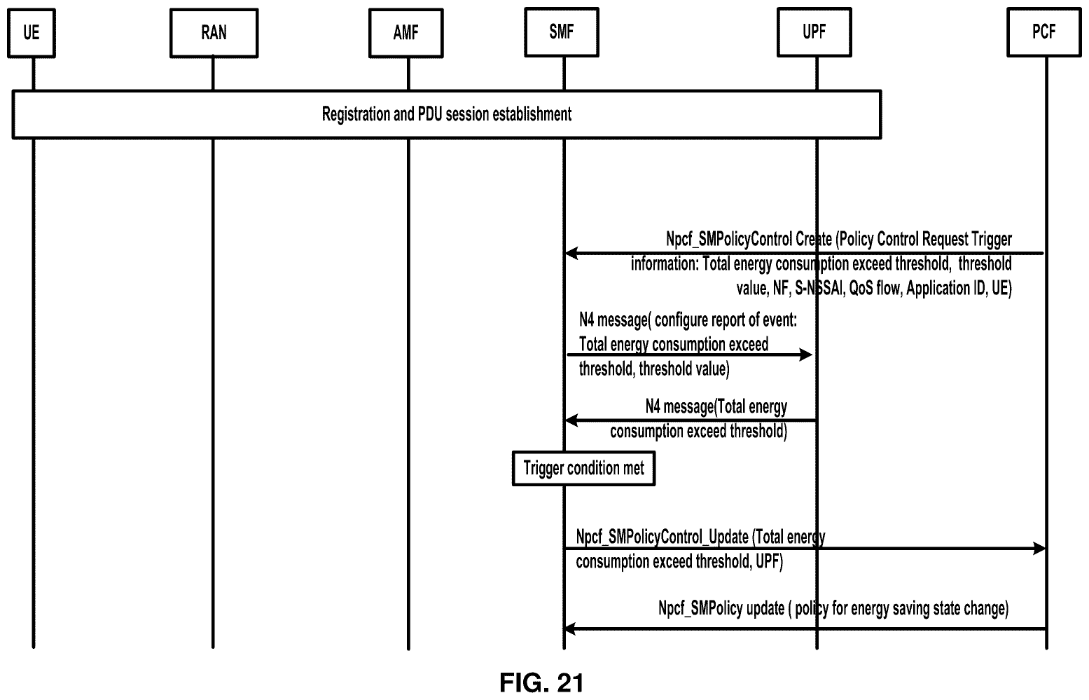

In an example, FIG. 21 depicts an example of configuring the UPF to report energy consumption related events. As described in an example embodiment of the present disclosure, the SMF may receive PCRT from the PCF, NN NF, EMF, NWDAF, EBF, and/or the like. In an example, the SMF may employ N4 messages to configure the UPF to report energy consumption related events. The N4 message may be an N4/PFCP session establishment/modification, an N4/PFCP association establishment/modification, and/or the like. In an example, the SMF in response to receiving the PCRT may determine to send the N4 message to the UPF. The N4 message may comprise a request to report an event. The event may comprise the energy consumption (EC) exceeding a threshold, the threshold value, and/or the like. The event may be applicable to the NE/NF, the PDU session, the QoS flow, the UE, an access type of the UE, an access leg of an MA PDU session, a RAT type, and/or the like. The Power/Energy consumption threshold may indicate a value that when exceeded a threshold, the SMF may send a report indicating that the power/energy consumption threshold has been reached. In an example, the report may indicate that the power/energy consumption threshold for a NF/NE has been reached. In an example, the report may indicate that the power/energy consumption threshold for a PDU session has been reached. In an example, the report may indicate that the power/energy consumption threshold for a S-NSSAI has been reached. In an example, the report may indicate that the power/energy consumption threshold for a UE has been reached. In an example, the report may indicate that the power/energy consumption threshold for an access leg, access type, RAT type of an MA PDU session has been reached.

In an example, based on the configuration information via the N4 message, the UPF may send a report when a condition has been met.

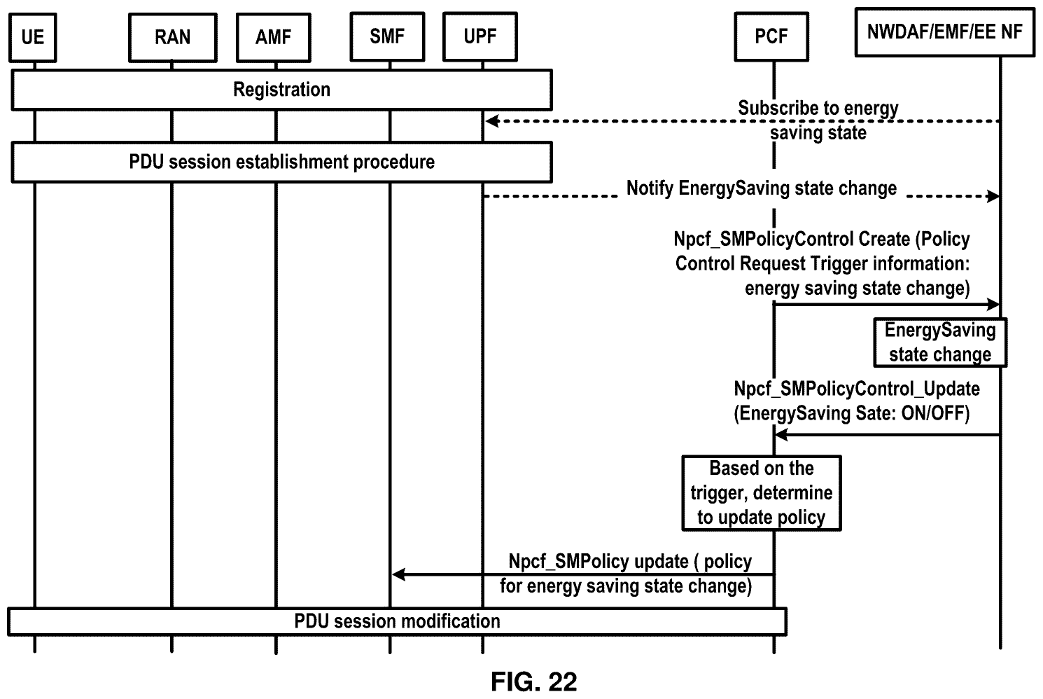

In an example as depicted in FIG. 22, Policy Control Request (PCR) Triggers relevant for NWDAF, EMF, EE NF, EBF, and/or the like may define the conditions when the NWDAF, the EMF, the EE NF, the EBF, and/or the like may interact again with PCF to request update of policy information. The Update of policy information may pertain to AM policy or SM policy, or UE policy. The following table depicts example Policy Control Request Triggers.

| Policy Control Request Trigger | Description |
|---|---|
| Energy consumption of PDU | EC level pertaining to resources |
| session exceed a threshold, | associated with a PDU session |
| threshold value | exceed threshold. |
| energy saving status (mode) | State of energy saving of the NF |
| of NF serving a PDU session | changed to ON or OFF. State of |
| | energy saving mode changed from/ |
| | to partial to/from full. |
| Energy consumption of a NF | EC level pertaining to resources |
| exceed threshold, threshold | associated with a NE/NF exceed |
| value | threshold. |
| Energy consumption of a QoS | EC level pertaining to resources |
| flow, S-NSSAI, UE, Application | associated with a QoS flow, S-NSSAI, |
| ID exceed threshold, threshold | UE, Application ID exceed threshold. |
| value | |

In an example, the PCF may configure the NWDAF, the EMF, the EE NF, the EBF, and/or the like to report the event (e.g., energy consumption related as described in example embodiments). The NWDAF, the EMF, the EE NF, the EBF, and/or the like, may collect EC related information from the network and when the trigger condition is met, send a message to the PCF triggering update of the policy information. The policy information update may be sent by the PCF to the AMF, the SMF, and/or the like.

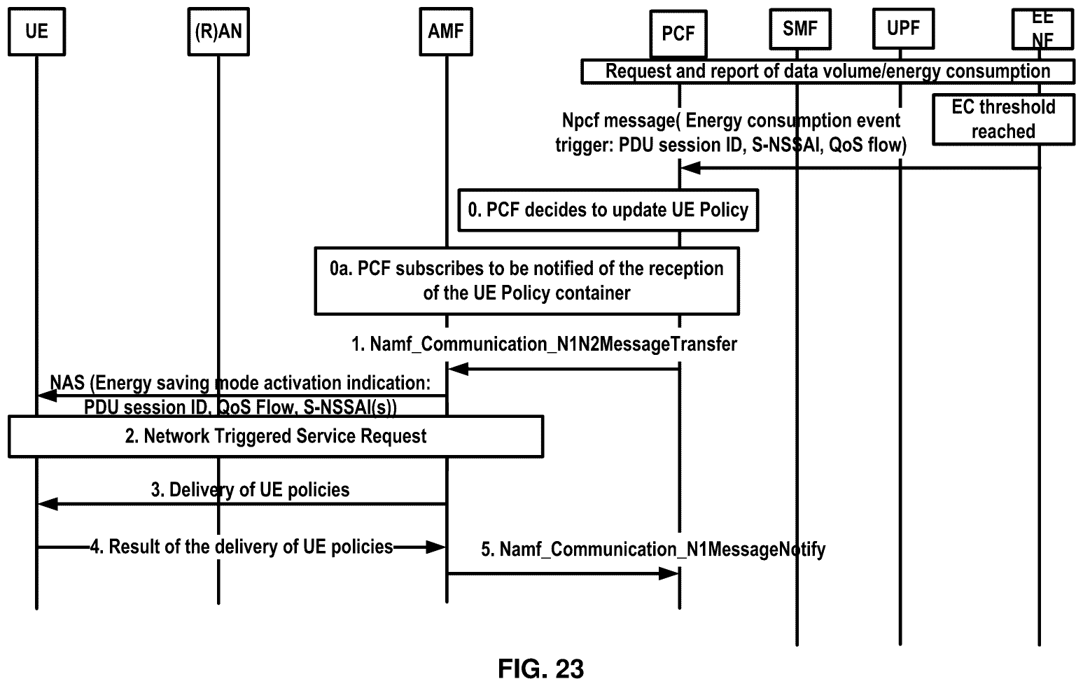

In an example embodiment as depicted in FIG. 23, the activation of ES state and policy update in response to the triggering condition being met, may cause policy update by the PCF. In an example, based on a trigger, the PCF may determine/decide to update UE policy based on triggering conditions such as an initial registration, registration with 5GS when the UE moves from EPS to 5GS, or need for updating UE policy as follows:

In an example, if the PCF has not subscribed to be notified by the AMF about the UE response to an update of UE policy information, the PCF subscribes to the AMF to be notified about the UE response to an update of UE policy information.

The PCF invokes Namf_Communication_N1N2MessageTransfer service operation provided by the AMF. The message includes SUPI, UE Policy Container. In an example, the UE may receive a NAS message from the AMF. The NAS message may comprise Energy saving mode activation indication for a PDU session ID, a QoS Flow, a S-NSSAI(s), a DNN, and/or the like.

If the UE is registered and reachable by AMF in either 3GPP access or non-3GPP access, AMF may transfers transparently the UE Policy container to the UE via the registered and reachable access.

If the UE is in CM-CONNECTED over 3GPP access or non-3GPP access, the AMF transfers transparently the UE Policy container (UE policy information) received from the PCF to the UE. The UE Policy container may comprise Energy saving mode activation indication for PDU session ID, QoS Flow, S-NSSAI(s).

The UE updates the UE policy provided by the PCF and sends the result to the AMF. The AMF forwards the response of the UE to the PCF using Namf_Communication_N1MessageNotify. The PCF maintains the latest list of PSIs delivered to the UE and updates the latest list of PSIs in the UDR by invoking Nudr_DM_Update (SUPI, Policy Data, Policy Set Entry, updated PSI data) service operation. If the PCF is notified about UE Policy delivery failure from the AMF, the PCF may initiate UE Policy Association Modification procedure to provide a new trigger “Connectivity state changes” in Policy Control Request Trigger of UE Policy Association to AMF. The PCF may re-initiate the UE Configuration Update procedure for transparent UE Policy delivery as in step 1 when the PCF is notified of the UE connectivity state changed to CONNECTED.

In an example embodiment, a session management function (SMF) may receive from a policy and charging control function (PCF), a policy control create message comprising a condition for triggering a policy control request, wherein the condition comprises a change in energy saving state of a network function (NF). In an example, the energy saving state may be associated with at least one of: a network slice, a quality of service (QOS) flow, a protocol data unit (PDU) session of a wireless device, and/or the like. In an example, the SMF may receive from a network data analytics function (NWDAF), a message notifying that the change in the energy saving state of the NF has occurred. In an example, the SMF may determine, and based on the message, that the condition is met. In an example, the SMF may send to the PCF, a policy control update indicating that the condition is met.

In an example, the energy saving state is associated with a NF that serves data packet transmission of an application (e.g., application ID). In an example, the SMF may receive from a wireless device via an access and mobility management function (AMF), a non-access stratum (NAS) message comprising a network controlled energy saving optimization support. In an example, the SMF may send to the PCF, a SM policy association establishment request based on an element of the NAS message. In an example, the policy association establishment request may comprise the network controlled energy saving optimization support indication. In an example, the SMF may receive from the PCF a policy information (SM policy information). In an example, the policy information may comprise at least one of: a slice policy information indicating whether a network slice usage is restricted due to energy consumption control by the network wherein the slice policy information comprises one or more S-NSSAI(s), a PDU session timer value indicating a time duration for which the PDU session may not use the S-NSSAI, and/or the like. In an example, the policy information may comprise at least one of: a Power/Energy consumption threshold indicating a value of energy consumed after which the SMF may report usage to the PCF for a monitoring key, an energy consumption (EC) time threshold indicating the resource time usage after which the SMF may report EC consumption report to the PCF an EC Monitoring time indicating a time at which the SMF may reapply the Power/Energy consumption threshold and/or EC Time Threshold, a volume threshold indicating the traffic volume value after which the SMF may report usage to the PCF for a monitoring key. In an example, the policy information may comprises at least one of: a per S-NSSAI data volume restriction value, a per S-NSSAI energy consumption restriction indication/value, a per S-NSSAI Energy consumption restriction period (time period), and/or the like. In an example, the SMF may send to a user plane function a message to configure reporting based on the policy information. In an example, the message may be an N4 message, or PFCP message comprising configuration parameters indicating to the UPF to report when: the Power/Energy consumption threshold indicating the value of energy consumed after which the UPF may report usage to the SMF, an EC Time threshold indicating the resource time usage after which the UPF may report EC consumption report to the SMF, an EC Monitoring time indicating a time at which the UPF may reapply the Power/Energy consumption threshold and/or EC Time Threshold, a volume threshold indicating the traffic volume value after which the UPF may report usage to the SMF, a per S-NSSAI data volume restriction value threshold indicating the value of data volume consumed after which the UPF may report usage to the SMF, a per S-NSSAI energy consumption restriction indication/value threshold indicating the value of energy consumed per S-NSSAI after which the UPF may report usage to the SMF, a per S-NSSAI Energy consumption restriction period (time period), and/or the like. In an example, the energy saving state may comprise: a state of notEnergySaving state indicating that the NF, NE, PDU session, S-NSSAI, QoS flow, UE, and/or the like may not be subject to energy saving control or monitoring, or a state of energySaving indicating that the NF, NE, PDU session, S-NSSAI, QoS flow, UE, and/or the like are subject to energy saving control or monitoring. In an example, the condition may comprise at least one of: an energy consumption of PDU session exceed a first threshold, the first threshold value, change of an energy saving status (mode) of NF serving a PDU session, an energy consumption of a NE/NF exceed a second threshold, the second threshold value, an energy consumption of a QoS flow, S-NSSAI, UE, Application ID exceed a third threshold, the third threshold value. In an example, the SMF may determine that a triggering condition has been met.

In an example embodiment, a session management function (SMF) may receive from a policy and charging control function (PCF), a policy control create message comprising a condition for triggering a policy control request. In an example, the condition may comprise a change in energy saving state of a network function (NF) associated with at least one of: a network slice, a quality of service (QOS) flow, a protocol data unit (PDU) session of a wireless device, and/or the like. In an example, the SMF may receive from a network data analytics function (NWDAF), a message notifying that the change in the energy saving state of the NF has occurred. In an example, the SMF may determine, and based on the message, that the condition is met. In an example, the SMF may send to the PCF, a session management (SM) policy control update indicating that the condition is met.

In an example embodiment, a policy and charging control function (PCF) may send to an energy efficiency network function (EE NF) a request for notification of a change in energy saving state of a network function (NF) associated with at least one of: a network slice, a quality of service (QOS) flow, a protocol data unit (PDU) session of a wireless device, ad/or the like. In an example, the PCF may receive from the EE NF, a message notifying that the change in the energy saving state of the NF has occurred. In an example, the PCF may determine and based on the message, to update a PCC rule. In an example, the PCF may send to a session management function (SMF), an updated policy.

In an example, the EE NF may comprises at least one of: a network data analytics function (NWDAF); an energy management function (EMF); an energy brokerage function (EBF), and/or the like. In an example, the request may comprise conditions for reporting an event to the PCF. In an example, the event may comprise an event that corresponds to energy consumption related events such as energy consumption exceeding a threshold. The energy consumption may be associated with the UE, the PDU session of the UE, a QoS flow of the UE, a QoS flow of the PDU session, a S-NSSAI, and/or the like. In an example, the event may be associated with a NF, or NE of the 3GPP network or the PLMN, SNPN, NPN. In an example, the SMF may receive from a wireless device via an access and mobility management function (AMF), a non-access stratum (NAS) message comprising a network controlled energy saving optimization support. The PCF may receive from the SMF, a SM policy association establishment request comprising a network controlled energy saving optimization support indication. The PCF may send to the SMF, a policy information (SM policy information). The policy information may comprise at least one of: a slice policy information indicating whether a network slice usage is restricted due to energy consumption control by the network, wherein the slice policy information comprises one or more S-NSSAI(s); and a PDU session timer value indicating a time duration for which the PDU session may not use the S-NSSAI. The policy information may comprise at least one of: a Power/Energy consumption threshold indicating a value of energy consumed after which the SMF may report usage to the PCF for a monitoring key; an EC Time threshold indicating the resource time usage after which the SMF may report EC consumption report to the PCF; an EC Monitoring time indicating a time at which the SMF may reapply the Power/Energy consumption threshold and/or EC Time Threshold, a volume threshold indicating the traffic volume value after which the SMF may report usage to the PCF for a monitoring key. The policy information may comprise at least one of: a per S-NSSAI data volume restriction value; a per S-NSSAI energy consumption restriction indication/value; and a per S-NSSAI Energy consumption restriction period (time period). The SMF may send to a user plane function a message to configure reporting based on the policy information. The message may be an N4 message, or PFCP message comprising configuration parameters indicating to the UPF to report when: the Power/Energy consumption threshold indicating the value of energy consumed after which the UPF may report usage to the SMF; an EC Time threshold indicating the resource time usage after which the UPF may report EC consumption report to the SMF; an EC Monitoring time indicating a time at which the UPF may reapply the Power/Energy consumption threshold and/or EC Time Threshold; and a volume threshold indicating the traffic volume value after which the UPF may report usage to the SMF; a per S-NSSAI data volume restriction value threshold indicating the value of data volume consumed after which the UPF may report usage to the SMF; a per S-NSSAI energy consumption restriction indication/value threshold indicating the value of energy consumed per S-NSSAI after which the UPF may report usage to the SMF; and a per S-NSSAI Energy consumption restriction period (time period). In an example, the energy saving state may comprise a state of notEnergySaving state indicating that the NF, NE, PDU session, S-NSSAI, QoS flow, UE, and/or the like may not be subject to energy saving control or monitoring; and a state of energySaving indicating that the NF, NE, PDU session, S-NSSAI, QoS flow, UE, and/or the like are subject to energy saving control or monitoring. In an example, the condition may comprise at least one of: an energy consumption of PDU session exceed a first threshold; the first threshold value; change of an energy saving status (mode) of NF serving a PDU session; an energy consumption of a NE/NF exceed a second threshold; the second threshold value; an energy consumption of a QoS flow, S-NSSAI, UE, Application ID exceed a third threshold; and the third threshold value. In an example, the PCF may determine that a triggering condition has been met.

In an example embodiment, a session management function (SMF) may receive from a policy and charging control function (PCF), a policy control create request message comprising a condition for triggering a policy control request, wherein the condition indicates a change in a status of energy consumption associated with a network function (NF) serving a protocol data unit (PDU) session of a wireless device. In an example, the SMF may receive from a user plane function (UPF), a message indicating the change. In an example, the SMF may determine and based on the message, that the condition is met. In an example, the SMF may send to the PCF, the policy control request indicating that the condition is met. In an example, the change may comprise activation of energy saving state of the NF.

What is claimed is:

1. A method comprising:
receiving, by a session management function (SMF) from a policy and charging control function (PCF), a policy control create message comprising a condition for triggering a policy control request, wherein the condition comprises a change in energy saving state of a network function (NF), wherein the energy saving state is associated with at least one of:
a network slice;
a quality of service (QOS) flow; and
a protocol data unit (PDU) session of a wireless device;
receiving, by the SMF from a network data analytics function (NWDAF), a message notifying that the change in the energy saving state of the NF has occurred;
determining, by the SMF and based on the message, that the condition is met; and
sending, by the SMF to the PCF, a policy control update indicating that the condition is met.

2. The method of claim 1, wherein the energy saving state is associated with a NF that serves data packet transmission of an application.

3. The method of claim 1, further comprising receiving by the SMF from a wireless device via an access and mobility management function (AMF), a non-access stratum (NAS) message comprising a network controlled energy saving optimization support indication.

4. The method of claim 3, further comprising sending by the SMF to the PCF, a SM policy association establishment request based on an element of the NAS message.

5. The method of claim 4, wherein the policy association establishment request comprises the network controlled energy saving optimization support indication.

6. The method of claim 1, further comprising receiving by the SMF from the PCF a policy information.

7. The method of claim 6, wherein the policy information comprises at least one of:
a slice policy information indicating whether a network slice usage is restricted due to energy consumption control by the network wherein the slice policy information comprises one or more S-NSSAI(s); and
a PDU session timer value indicating a time duration for which the PDU session may not use the one or more S-NSSAI(s).

8. A session management function (SMF) comprising one or more processors and memory storing instructions that, when executed by the one or more processors, cause the SMF to:
receive, from a policy and charging control function (PCF), a policy control create message comprising a condition for triggering a policy control request, wherein the condition comprises a change in energy saving state of a network function (NF), wherein the energy saving state is associated with at least one of:
a network slice;
a quality of service (QOS) flow; and
a protocol data unit (PDU) session of a wireless device;
receive, from a network data analytics function (NWDAF), a message notifying that the change in the energy saving state of the NF has occurred;
determine, based on the message, that the condition is met; and
send, to the PCF, a policy control update indicating that the condition is met.

9. The SMF of claim 8, wherein the energy saving state is associated with a NF that serves data packet transmission of an application.

10. The SMF of claim 8, wherein the instructions further cause the SMF to receive, from a wireless device via an access and mobility management function (AMF), a non-access stratum (NAS) message comprising a network controlled energy saving optimization support indication.

11. The SMF of claim 10, wherein the instructions further cause the SMF to send, to the PCF, a SM policy association establishment request based on an element of the NAS message.

12. The SMF of claim 11, wherein the policy association establishment request comprises the network controlled energy saving optimization support indication.

13. The SMF of claim 8, wherein the instructions further cause the SMF to receive, from the PCF a policy information.

14. The SMF of claim 13, wherein the policy information comprises at least one of:
a slice policy information indicating whether a network slice usage is restricted due to energy consumption control by the network wherein the slice policy information comprises one or more S-NSSAI(s); and
a PDU session timer value indicating a time duration for which the PDU session may not use the one or more S-NSSAI(s).

15. A non-transitory computer-readable medium storing instructions that, when executed by one or more processors of a session management function (SMF), cause the SMF to:
receive, from a policy and charging control function (PCF), a policy control create message comprising a condition for triggering a policy control request, wherein the condition comprises a change in energy saving state of a network function (NF), wherein the energy saving state is associated with at least one of:
a network slice;
a quality of service (QOS) flow; and
a protocol data unit (PDU) session of a wireless device;
receive, from a network data analytics function (NWDAF), a message notifying that the change in the energy saving state of the NF has occurred;
determine, based on the message, that the condition is met; and
send, to the PCF, a policy control update indicating that the condition is met.

16. The non-transitory computer-readable medium of claim 15, wherein the energy saving state is associated with a NF that serves data packet transmission of an application.

17. The non-transitory computer-readable medium of claim 15, wherein the instructions further cause the SMF to receive, from a wireless device via an access and mobility management function (AMF), a non-access stratum (NAS) message comprising a network controlled energy saving optimization support indication.

18. The non-transitory computer-readable medium of claim 17, wherein the instructions further cause the SMF to send, to the PCF, a SM policy association establishment request based on an element of the NAS message.

19. The non-transitory computer-readable medium of claim 18, wherein the policy association establishment request comprises the network controlled energy saving optimization support indication.

20. The non-transitory computer-readable medium of claim 15, wherein the instructions further cause the SMF to receive, from the PCF a policy information.
